(19) United States
(12) Patent Application Publication
(10) Pub. No.: US 2024/0014971 A1
(43) Pub. Date: Jan. 11, 2024

(54) MEDIUM ACCESS CONTROL (MAC) CONTROL ELEMENT BASED SRS RESOURCE CONFIGURATION

(71) Applicant: QUALCOMM Incorporated, San Diego, CA (US)

(72) Inventors: Ruiming ZHENG, Beijing (CN); Yu ZHANG, San Diego, CA (US); Muhammad Sayed Khairy ABDELGHAFFAR, San Jose, CA (US); Linhai HE, San Diego, CA (US); Alexandros MANOLAKOS, Escondido, CA (US); Krishna Kiran MUKKAVILLI, San Diego, CA (US); Tingfang JI, San Diego, CA (US)

(21) Appl. No.: 17/911,628

(22) PCT Filed: Mar. 24, 2020
(86) PCT No.: PCT/CN2020/080862

§ 371 Date: Sep. 14, 2022

(51) Int. Cl. H04L 5/00; H04W 72/232; H04W 72/04

(52) U.S. Cl. CPC H04L 5/0051; H04W 72/232; H04W 72/04

(57) ABSTRACT

Aspects of the present disclosure provide methods and apparatus for controlling sounding reference signal (SRS) resources in wireless communication using medium access control (MAC) control element (CE). A user equipment receives a MAC CE from a network, the MAC CE comprising information for activating or deactivating one or more SRS resources included in at least one SRS resource set. The user equipment transmits an SRS communication using the one or more SRS resources included in the at least one SRS resource set based on the information of the MAC CE.

### TECHNICAL FIELD

The technology discussed below relates generally to wireless communication systems, and more particularly, to methods and apparatus for controlling and configuring sounding reference signal (SRS) in wireless communication.

### BACKGROUND

In a wireless communication system, a sounding reference signal (SRS) may be used to characterize a wireless channel between a mobile device and a network, enabling accurate and dynamic adaptation of communication signaling based on the carrier characterization. An SRS may be transmitted on one or more symbols on an uplink carrier by a mobile device. The SRS provides a measurement reference, which the network may use to discover information relating to the uplink carrier quality. The network can then use its measurements or calculations based on the SRS for any channel-dependent scheduling that it may send to the mobile device for scheduling uplink transmissions, such as frequency-selective resource allocation. Further, the network may use the SRS for uplink power control, time tracking, or adaptive antenna switching for transmit diversity.

In a fifth-generation (5G) New Radio (NR) access network, the format and configuration of an SRS may be different from that of prior access networks. In particular, because a NR access network may use different and/or more frequency bands, may have different timing and latency requirements, and may use different transmission schemes and channel structures in comparison to legacy access networks; the sounding procedure and the configuration of an SRS from those earlier standards may not be suitable. Research and development continue to advance wireless communication technologies not only to meet the growing demand for mobile broadband access, but to advance and enhance the user experience with mobile communications.

### BRIEF SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide methods and apparatus for controlling sounding reference signal (SRS) resources in wireless communication using medium access control (MAC) control element (CE).

A first embodiment of wireless communication at a scheduled entity, including: receiving a medium access control (MAC) control element (CE) from a network, the MAC CE comprising information for activating or deactivating one or more sounding reference signal (SRS) resources included in at least one SRS resource set; and transmitting an SRS communication using the one or more SRS resources included in the at least one SRS resource set based on the information of the MAC CE.

A second embodiment in combination with the first embodiment, wherein the MAC CE further comprises an SRS slot offset field configured to indicate a slot offset between a triggering downlink control information (DCI) and the at least one SRS resource set this is activated. A third embodiment in combination with the second embodiment, wherein the MAC CE further comprises a content field configured to indicate alternative values represented by the SRS slot offset field according to a value of the content field. A fourth embodiment in combination with the first embodiment, wherein the MAC CE further comprises a channel-state information reference signal (CSI-RS) field configured to indicate a CSI-RS associated with the at least one SRS resource set.

A fifth embodiment in combination with any of the first to fourth embodiments, wherein the MAC CE comprises: an SRS resource set field configured to indicate an SRS resource set; and an SRS resource field configured to indicate the one or more SRS resources included in the at least one SRS resource set. A sixth embodiment in combination with the fifth embodiment, wherein the SRS resource field is configured to activate or deactivate the one or more SRS resources according to a plurality of downlink control information (DCI) codepoints for triggering aperiodic, semi-persistent, or periodic SRS resources included in the at least one SRS resource set.

A seventh embodiment in combination with any of the first to fourth embodiments, wherein the MAC CE comprises: an SRS resource set bitmap comprising a plurality of bits, each bit configured to indicate activation or deactivation of a corresponding SRS resource set of the at least one SRS resource set; and an SRS resource field configured to indicate the one or more SRS resources included in an activated SRS resource set of the at least one SRS resource set based on the SRS resource set bitmap. An eighth embodiment in combination with the seventh embodiment, wherein the SRS resource field is configured to activate or deactivate the one or more SRS resources according to a plurality of downlink control information (DCI) codepoints for triggering aperiodic, semi-persistent, or periodic SRS resources included in the activated SRS resource set.

A ninth embodiment in combination with any of the first to fourth embodiments, wherein the MAC CE comprises: a download control information (DCI) codepoint bitmap configured to indicate one or more activated DCI codepoints for triggering aperiodic, semi-persistent, or periodic SRS; an SRS resource set field, associated with the DCI codepoint bitmap, configured to indicate an SRS resource set of the at least one SRS resource set; and an SRS resource field configured to indicate the one or more SRS resources included in the SRS resource set. A tenth embodiment in combination with the ninth embodiment, wherein the SRS resource field is configured to activate or deactivate the one or more SRS resources according to the one or more activated DCI codepoints.

An eleventh embodiment in combination with any of the first to fourth embodiments, wherein the MAC CE comprises: an SRS resource set field configured to indicate an SRS resource set of the at least one SRS resource set; and a plurality of SRS resource trigger state fields, associated with the SRS resource set, the plurality of SRS resource trigger state fields configured to indicate a plurality of SRS resource trigger states that are preconfigured by radio resource control signaling. A twelfth embodiment in combination with the eleventh embodiment, wherein the plurality of SRS resource trigger state fields respectively correspond to a plurality of downlink control information (DCI) codepoints for triggering aperiodic, semi-persistent, or periodic SRS resources included in the SRS resource set. A thirteenth embodiment in combination with the eleventh embodiment, wherein each of the plurality of SRS resource trigger states indicates activation or deactivation of each of the one or more SRS resources for the SRS resource set.

A fourteenth embodiment in combination with any of the first to fourth embodiments, wherein the MAC CE comprises: an SRS resource set field configured to indicate an SRS resource set of the at least one SRS resource set; and an SRS trigger state bitmap with each bit indicating activation or deactivation of a corresponding SRS trigger state of the SRS resource set among a plurality of SRS trigger states that are preconfigured by radio resource control signaling. A fifteenth embodiment in combination with the fourteen embodiment, wherein the activated SRS trigger states correspond to a plurality of downlink control information (DCI) codepoints for triggering aperiodic, semi-persistent, or periodic SRS resources included in the SRS resource set.

A sixteenth embodiment in combination with any of the first to fourth embodiments, wherein the MAC CE comprises: an SRS resource set bitmap comprising a plurality of bits, each bit configured to indicate activation or deactivation of a corresponding SRS resource set of the at least one SRS resource set; and a plurality of SRS resource trigger state fields, associated with the corresponding SRS resource set, the plurality of SRS resource trigger state fields configured to indicate a plurality of SRS resource trigger states that are preconfigured by radio resource control signaling. A seventeenth embodiment in combination with the sixteenth embodiment, wherein the plurality of SRS resource trigger state fields respectively correspond to a plurality of downlink control information (DCI) codepoints for triggering aperiodic, semi-persistent, or periodic SRS sources included in the corresponding activated SRS resource set.

An eighteenth embodiment in combination with any of the first to fourth embodiments, wherein the MAC CE comprises: an SRS resource set bitmap comprising a plurality of bits, each bit configured to indicate activation or deactivation of a corresponding SRS resource set of the at least one SRS resource set; and an SRS trigger state bitmap with each bit indicating activation or deactivation of a corresponding SRS trigger state of the corresponding SRS resource set among a plurality of SRS trigger states that are preconfigured by radio resource control signaling. A nineteenth embodiment in combination with eighteenth embodiment, wherein the activated SRS trigger states correspond to a plurality of downlink control information (DCI) codepoints for triggering aperiodic, semi-persistent, or periodic SRS resources included in the corresponding activated SRS resource set.

A twentieth embodiment in combination with any of the first to fourth embodiments, wherein the MAC CE comprises: a download control information (DCI) codepoint bitmap configured to indicate one or more activated DCI codepoints for triggering aperiodic, semi-persistent, or periodic SRS; an SRS resource set field, associated with the DCI codepoint bitmap, configured to indicate an SRS resource set of the at least one SRS resource set; and one or more SRS resource trigger state fields, associated with the SRS resource set, each SRS resource trigger state field configured to indicate a resource trigger state that is preconfigured by radio resource control signaling. A twenty-first embodiment in combination with the twentieth embodiment, wherein each of the one or more SRS resource trigger state fields corresponds to one of the activated DCI codepoints.

A twenty-second embodiment at a scheduled entity, including: receiving a medium access control (MAC) control element (CE) from a network, the MAC CE comprising: a sounding reference signal (SRS) resource set field configured to indicate an SRS resource set for SRS communication; and a channel-state information reference signal (CSI-RS) field configured to indicate a CSI-RS resource for receiving a CSI-RS signal from network. A twenty-third embodiment in combination with the twenty-second embodiment, wherein the CSI-RS resource is associated with the SRS resource set. A twenty-fourth embodiment in combination with the twenty-second embodiment, wherein the SRS resource set field is configured to indicate a periodic SRS resource set, a semi-persistent SRS resource set, or aperiodic SRS resource set. A twenty-fifth embodiment in combination with twenty-second or twenty-fourth embodiment, wherein the CSI-RS field is configured to indicate the CSI-RS from a non-zero-power CSI-RS resource space.

A twenty-sixth embodiment at a scheduling entity, including: transmitting a medium access control (MAC) control element (CE) to a user equipment (UE), the MAC CE comprising information for activating or deactivating one or more sounding reference signal (SRS) resources included in at least one SRS resource set; and receiving, from the UE, an SRS communication using the one or more SRS resources included in the at least one SRS resource set based on the information of the MAC CE. A twenty-seventh embodiment in combination with the twenty-sixth embodiment, wherein the MAC CE further comprises: an SRS slot offset field configured to indicate a slot offset between a triggering downlink control information (DCI) and the at least one SRS resource set that is activated.

A twenty-eighth embodiment in combination with the twenty-sixth embodiment, wherein the MAC CE further comprises: a content field configured to indicate alternative values represented by the SRS slot offset field according to a value of the content field. A twenty-ninth embodiment in combination with the twenty-sixth embodiment, wherein the MAC CE further comprises: a channel-state information reference signal (CSI-RS) field configured to indicate a CSI-RS associated with the at least one SRS resource set.

A thirtieth embodiment at a scheduling entity, including: transmitting a medium access control (MAC) control element (CE) to a user equipment (UE), the MAC CE comprising: a sounding reference signal (SRS) resource set field configured to indicate an SRS resource set for SRS communication, and a channel-state information reference signal (CSI-RS) field configured to indicate a CSI-RS resource for transmitting a CSI-RS; and transmitting, to the UE, the CSI-RS using the CSI-RS resource.

A thirty-first embodiment in combination with the thirtieth embodiment, wherein the CSI-RS resource is associated with the SRS resource set. A thirty-second embodiment in combination with the thirtieth embodiment, wherein the SRS resource set field is configured to indicate a periodic SRS resource set, a semi-persistent SRS resource set, or aperiodic SRS resource set. A thirty-third embodiment in combination with the thirtieth or thirty-second embodiment, wherein the CSI-RS field is configured to indicate the CSI-RS from a non-zero-power CSI-RS resource space.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects of the present disclosure.

FIG. 2 is a conceptual illustration of an example of a radio access network according to some aspects of the disclosure.

FIG. 3 is a block diagram illustrating a wireless communication system supporting multiple-input multiple-output (MIMO) communication.

FIG. 4 is a schematic illustration of an organization of wireless resources in an air interface utilizing orthogonal frequency divisional multiplexing (OFDM) according to some aspects of the disclosure.

FIG. 5 is a drawing illustrating a first design of a medium access control (MAC) control element (CE) for sounding reference signal (SRS) resource control according to some aspects of the disclosure.

FIG. 6 is a drawing illustrating a second design of a MAC CE for SRS resource control according to some aspects of the disclosure.

FIG. 7 is a drawing illustrating a third design of a MAC CE for SRS resource control according to some aspects of the disclosure.

FIG. 8 is a drawing illustrating a fourth design of a MAC CE for SRS resource control according to some aspects of the disclosure.

FIG. 9 is a drawing illustrating a fifth design of a MAC CE for SRS resource control according to some aspects of the disclosure.

FIG. 10 is a drawing illustrating a sixth design of a MAC CE for SRS resource control according to some aspects of the disclosure.

FIG. 11 is a drawing illustrating a seventh design of a MAC CE for SRS resource control according to some aspects of the disclosure.

FIG. 12 is a drawing illustrating an eighth design of a MAC CE for SRS resource control according to some aspects of the disclosure.

FIG. 13 is a drawing illustrating a design of a MAC CE for updating aperiodic SRS resource slot offset according to some aspects of the disclosure.

FIG. 14 is a drawing illustrating a first design of a MAC CE for aperiodic SRS resource control and slot offset update according to some aspects of the disclosure.

FIG. 15 is a drawing illustrating a second design of a MAC CE for aperiodic SRS resource control and slot offset update according to some aspects of the disclosure.

FIG. 16 is a drawing illustrating a third design of a MAC CE for aperiodic SRS resource control and slot offset update according to some aspects of the disclosure.

FIG. 17 is a drawing illustrating a fourth design of a MAC CE for aperiodic SRS resource control and slot offset update according to some aspects of the disclosure.

FIG. 18 is a drawing illustrating a fifth design of a MAC CE for aperiodic SRS resource control and slot offset update according to some aspects of the disclosure.

FIG. 19 is a drawing illustrating a design of a MAC CE for updating the associated channel-state information reference signal (CSI-RS) information for an SRS resource set according to some aspects of the disclosure.

FIG. 20 is a block diagram conceptually illustrating an example of a hardware implementation for a scheduled entity according to some aspects of the disclosure.

FIG. 21 is a flow chart illustrating an exemplary process for wireless communication at a scheduled entity using a MAC CE according to some aspects of the disclosure.

FIG. 22 is a flow chart illustrating another exemplary process for wireless communication at a scheduled entity using a MAC CE according to some aspects of the disclosure.

FIG. 23 is a block diagram conceptually illustrating an example of a hardware implementation for a scheduling entity according to some aspects of the disclosure.

FIG. 24 is a flow chart illustrating an exemplary process for wireless communication at a scheduling entity using a MAC CE according to some aspects of the disclosure.

FIG. 25 is a flow chart illustrating another exemplary process for wireless communication at a scheduling entity using a MAC CE according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

Aspects of the present disclosure provide methods and apparatus for controlling and configuring sounding reference signal (SRS) in wireless communication. SRS is an uplink (UL) reference signal that is transmitted by a user equipment (UE) to a base station or scheduling entity. Based on the SRS, the scheduling entity can determine or estimate the channel quality between the UE and the scheduling entity. Some aspects of the present disclosure provided herein are generally directed towards SRS control, update, and configuration using a medium access control (MAC) control element (CE). Some aspects of the present disclosure are generally directed to channel-state information reference signals (CSI-RS) configuration using MAC CE.

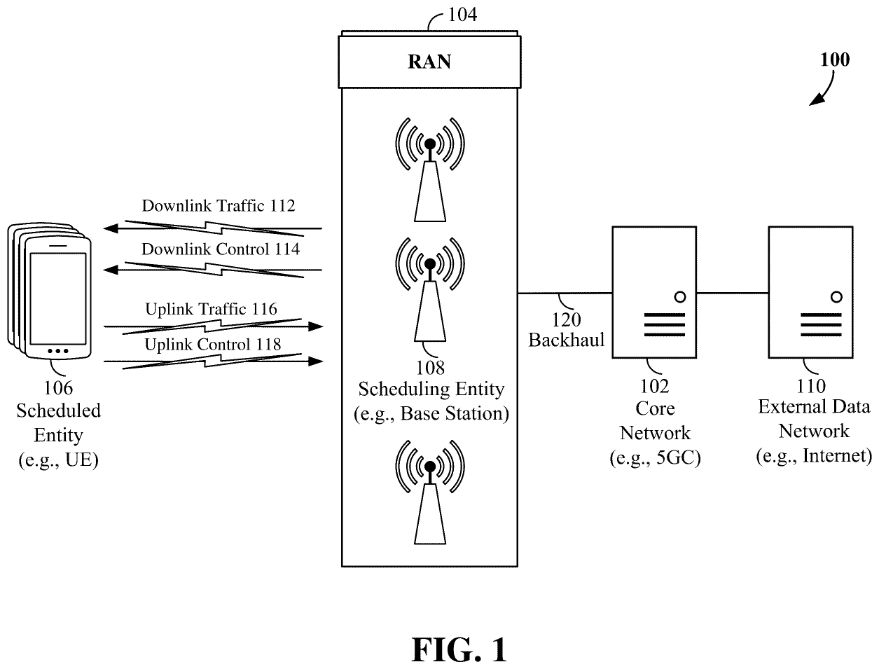

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

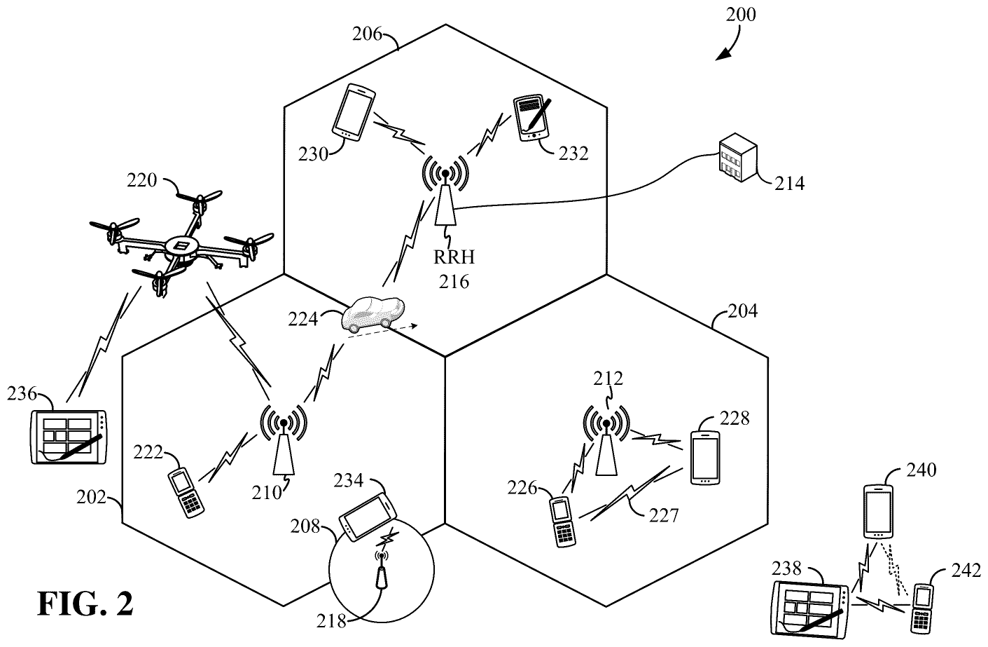

FIG. 2 is a conceptual illustration of an example of a radio access network (RAN) 200 according to some aspects. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 126 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time—frequency resources and having a cellular configuration, a P2P configuration, or a mesh configuration, a scheduling entity and one or more scheduled entities may communicate utilizing the scheduled resources.

The air interface in the radio access network 200 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

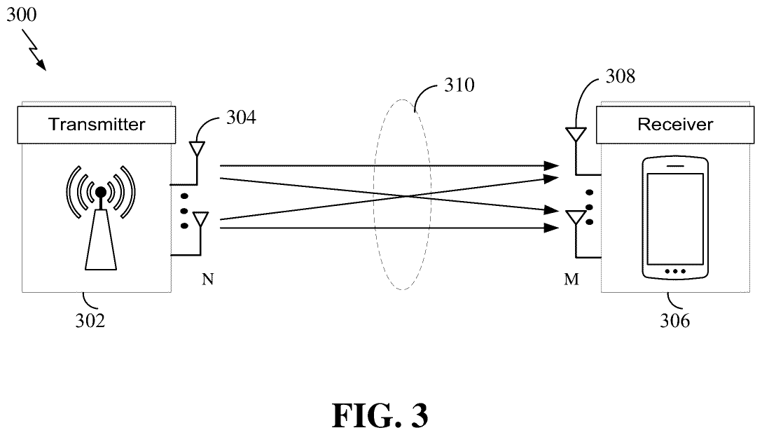

In some aspects of the disclosure, the scheduling entity and/or scheduled entity may be configured for beamforming and/or multiple-input multiple-output (MIMO) technology. FIG. 3 illustrates an example of a wireless communication system 300 supporting MIMO. In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system 300 is limited by the number of transmit or receive antennas 304 or 308, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on a Sounding Reference Signal (SRS) transmitted from the UE or other pilot signal). Based on the assigned rank, the base station may then transmit the CSI-RS with separate CSI-RS sequences for each layer to provide for multi-layer channel estimation. From the CSI-RS, the UE may measure the channel quality across layers and resource blocks and feed back the CQI and RI values to the base station for use in updating the rank and assigning REs for future downlink transmissions.

In the simplest case, as shown in FIG. 3, a rank-2 spatial multiplexing transmission on a 2×2 MIMO antenna configuration will transmit one data stream from each transmit antenna 304. Each data stream reaches each receive antenna 308 along a different signal path 310. The receiver 306 may then reconstruct the data streams using the received signals from each receive antenna 308.

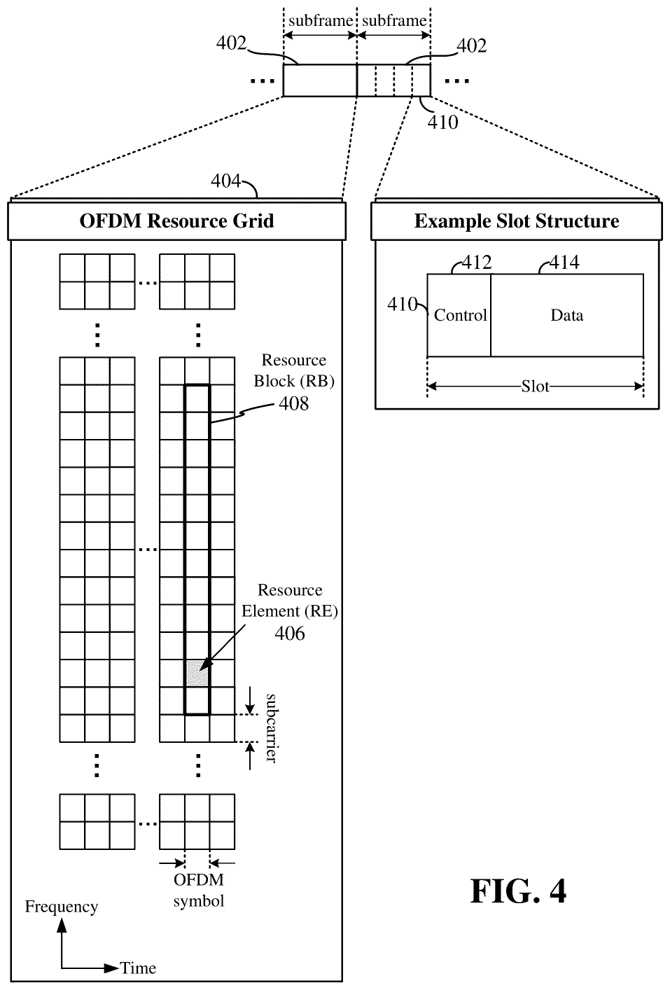

Various aspects of the present disclosure will be described with reference to an OFDM waveform, schematically illustrated in FIG. 4. It should be understood by those of ordinary skill in the art that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

Within the present disclosure, a frame refers to a duration of 10 ms for wireless transmissions, with each frame consisting of 10 subframes of 1 ms each. On a given carrier, there may be one set of frames in the UL, and another set of frames in the DL. Referring now to FIG. 4, an expanded view of an exemplary DL subframe 402 is illustrated, showing an OFDM resource grid 404. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 404 may be used to schematically represent time—frequency resources for a given antenna port. That is, in a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time—frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A UE generally utilizes only a subset of the resource grid 404. An RB may be the smallest unit of resources that can be allocated to a UE. Thus, the more RBs scheduled for a UE, and the higher the modulation scheme chosen for the air interface, the higher the data rate for the UE.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each subframe 402 (e.g., a 1 ms subframe) may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., 1, 2, 4, or 7 OFDM symbols). These mini-slots may in some cases be transmitted occupying resources scheduled for ongoing slot transmissions for the same or for different UEs.

An expanded view of one of the slots 410 illustrates the slot 410 including a control region 412 and a data region 414. In general, the control region 412 may carry control channels (e.g., PDCCH), and the data region 414 may carry data channels (e.g., PDSCH or PUSCH). Of course, a slot may contain all DL, all UL, or at least one DL portion and at least one UL portion. The simple structure illustrated in FIG. 4 is merely exemplary in nature, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In a DL transmission, the transmitting device (e.g., the scheduling entity 108) may allocate one or more REs 406 (e.g., within a control region 412) to carry DL control information 114 including one or more DL control channels that generally carry information originating from higher layers, such as a physical broadcast channel (PBCH), a physical downlink control channel (PDCCH), etc., to one or more scheduled entities 106. In addition, DL REs may be allocated to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

The synchronization signals PSS and SSS (collectively referred to as SS), and in some examples, the PBCH, may be transmitted in an SS block that includes 4 consecutive OFDM symbols, numbered via a time index in increasing order from 0 to 3. In the frequency domain, the SS block may extend over 240 contiguous subcarriers, with the subcarriers being numbered via a frequency index in increasing order from 0 to 239. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a scheduled entity 106) may utilize one or more REs 406 to carry UL control information 118 (UCI). The UCI can originate from higher layers via one or more UL control channels, such as a physical uplink control channel (PUCCH), a physical random access channel (PRACH), etc., to the scheduling entity 108. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the scheduling entity 108 to schedule uplink transmissions. Here, in response to the SR transmitted on the control channel 118, the scheduling entity 108 may transmit downlink control information 114 that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a NACK, the transmitting device may send a HARQ retransmission, which may implement chase combining, incremental redundancy, etc.

In addition to control information, one or more REs 406 (e.g., within the data region 414) may be allocated for user data or traffic data. Such traffic may be carried on one or more traffic channels, such as, for a DL transmission, a physical downlink shared channel (PDSCH); or for an UL transmission, a physical uplink shared channel (PUSCH).

The channels or carriers described above are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

### Exemplary Implementations

In a wireless network such as LTE or NR, SRS antenna switching can enable downlink (DL) beamforming in TDD bands by exploiting channel reciprocity and UL sounding (e.g., for PUSCH scheduling/beamforming). A UE may have more receive (Rx) antennas than transmit (Tx) antenna(s). In an SRS antenna switching operation, the UE can transmit SRS using the Rx antennas to sound out the channels such that the scheduling entity may determine the DL channel quality of each RX antenna for DL beamforming. During antenna switching, the UE can switch among the Rx antennas when transmitting the SRS. NR Release 15 can support SRS antenna switching up to four receive (Rx) antennas depending on the capability of a UE. Some exemplary antenna switching configurations are 1T2R, 1T4R, 2T4R, and T=R. The 1T2R antenna configuration denotes one transmit antenna selected from two receive antennas. The 1T4R antenna configuration denotes one transmit antenna selected from four receive antennas. The 2T4R antenna configuration denotes two transmit antennas selected from four receive antennas. The NR specification currently supports NR SRS resources that can span 1, 2, or 4 adjacent symbols with up to 4 antenna ports per SRS resource. The NR specification may allow the use of multiple SRS resource sets for SRS sounding with antenna switching.

In some aspects of the disclosure, a UE may have more than four antennas that can be used for SRS antenna switching. For example, a UE may have 8 Rx antennas that can be used for various SRS antenna switching schemes such as 1T8R, 2T8R, 4T8R, etc. Therefore, in some aspects of the disclosure, an SRS resource set may contain up to 8 SRS resources, or more than 2 SRS resource sets may be defined with a total of 8 resources across all the resource sets for SRS antenna switching. It is also contemplated in this disclosure that an SRS antenna switching scheme can be extended to support more than 4 antenna ports.

A given SRS resource can be configured as aperiodic, periodic, or semi-persistent. According to a periodic configuration, the SRS resource is configured with a slot-level periodicity and slot offset. According to a semi-persistent configuration, the SRS resource is configured with a slot-level periodicity and slot offset, and the semi-persistent SRS resource set can be controlled (e.g., activated or deactivated) using a media access control (MAC) control element (CE). According to an aperiodic configuration, the SRS transmission can be triggered using downlink control information (DCI) in a downlink control channel (e.g., PDCCH), and aperiodic SRS resource(s) are triggered on a per set basis by DCI.

Current Release-15 NR specification uses a 2-bit SRS request field included in a DCI to trigger the transmission of an aperiodic SRS. Each (non-zero) codepoint of the SRS request field may correspond to an SRS trigger state. For example, the codepoints of a 2-bit field are 0 (bits 00), 1 (bits 10), 2 (bits 10), and 3 (bits 11). Each SRS resource set belongs to one or more SRS-trigger states. In some examples, the SRS-trigger states may be stored in a list or table (e.g., AperiodicSRS-ResourceTriggerList) with each entry (e.g., AperiodicSRS-ResourceTrigger) corresponding to an SRS-trigger state. Therefore, the AperiodicSRS-ResourceTriggerList indicates the association between aperiodic SRS triggering states and SRS resource sets. When an SRS trigger state is triggered, all the SRS resource(s) of the resource set associated with the triggered state are triggered.

While the above-described SRS triggering scheme may work well with up to 4 antennas used for SRS antenna switching, it may not be efficient and cause undesirably large overhead when more antennas are used. For example, for a UE with 8 Rx antennas, up to 8 SRS resources in one resource set associated with a triggered state are triggered at one time. It will result in undesirably large overhead if all 8 SRS resources are enabled at the same time.

Some aspects of the present disclosure provide various MAC CE based SRS resource control schemes that can provide an efficient way of configuring and controlling SRS resources for SRS antenna switching and triggering aperiodic SRS. In some aspects of the disclosure, a scheduling entity can transmit a MAC CE command to a UE or scheduled entity in order to perform dynamic activation and deactivation of SRS resources of one or more SRS resource sets. In one aspect, for all periodic, semi-persistent, and aperiodic SRS resource sets, the MAC CE may include an N-bit field (N is the number of SRS resources available in an SRS resource set) for controlling which of the SRS resources of the set is/are switched on (activated) or off (deactivated). In one aspect, for aperiodic SRS resource sets, the MAC CE may indicate whether an SRS resource of an SRS resource set is activated or deactivated for a subset of the configured DCI codepoints. In one example, if an aperiodic SRS resource set with 4 SRS resources (e.g., first, second, third and fourth SRS resources) can be triggered with DCI codepoints 1 and 2, then the MAC CE command may indicate that for codepoint 1, the first and third SRS resources are activated; whereas for codepoint 2, the second and fourth SRS resources are activated.

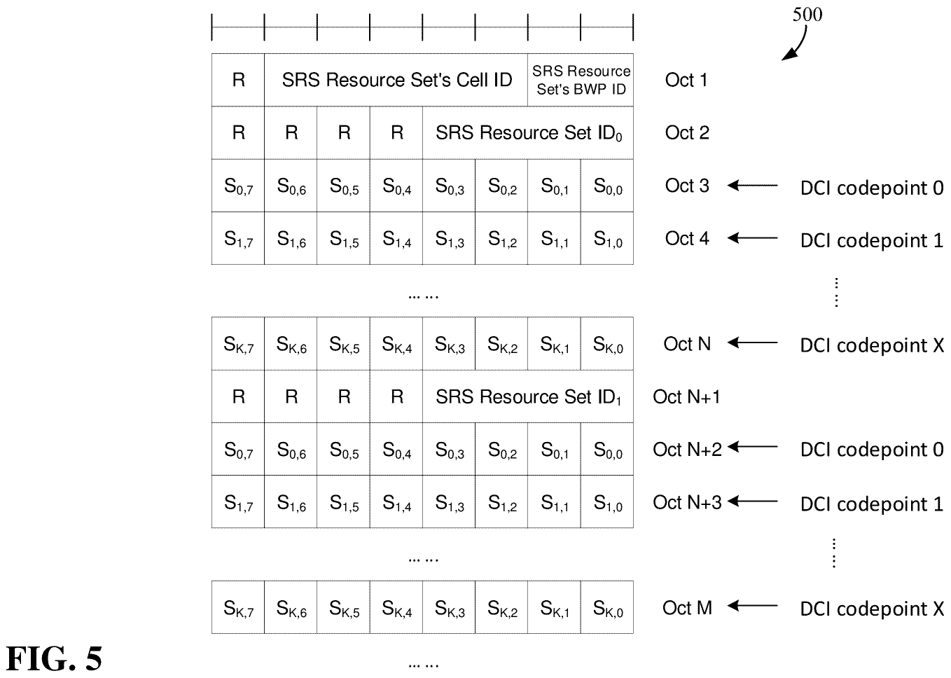

FIG. 5 is a drawing illustrating a design of a MAC CE 500 for SRS resource control according to some aspects of the disclosure. A scheduling entity 108 may transmit the MAC CE 500 to a scheduled entity 106 (e.g., UE) in an NR RAN 200 for configuring and controlling SRS communication. The MAC CE 500 has a predetermined number of bits arranged in various bit fields. Some of the bits may be reserved (denoted as R in FIG. 5). The MAC CE 500 has an SRS resource set cell ID field (illustrated as SRS Resource Set's Cell ID in FIG. 5) that identifies the cell that is associated with the SRS resource set(s) associated with this MAC CE. The MAC CE 500 has an SRS resource set BWP ID field (illustrated as SRS Resource Set's BWP ID in FIG. 5) that identifies the bandwidth part (BWP) that is configured with the SRS resources set(s) associated with this MAC CE.

The MAC CE 500 further includes one or more SRS resource set ID fields. Each SRS resource set ID field indicates the SRS resource set ID to which the following SRS resources (S_{i,j}) belong to. Two exemplary SRS resource set ID fields (e.g., SRS Resource Set ID₀ and SRS Resource Set ID₁) are illustrated in FIG. 5. The SRS resource sets may be configured with one of the resource set types, for example, periodic, semi-persistent, or aperiodic. The S_{i,j} fields represent the SRS resources within the corresponding SRS resource set identified by the SRS resource set ID field. For example, for SRS Resource Set ID₀, the SRS resources are indicated by multiple groups of S_{i,j} that follow the SRS Resource Set ID₀ field in the MAC CE. The S_{i,j} may be arranged in multiple octets, and each octet of the S_{i,j} corresponds to a DCI codepoint. If any S_{i,j} is set to 1, the corresponding SRS resource is activated (i.e., turned on or enabled); otherwise, the SRS resource is deactivated (i.e., turned off or disabled).

In this example, up to eight SRS resources may be included in one resource set. The i subscript of S_{i,j} indicates the corresponding DCI codepoint, and the j subscript of S_{i,j} indicates the corresponding SRS resource j configured for SRS antenna switching, for example, with “antennaSwitching” purpose set inside the srs-ResourceldList of the RRC parameter SRS-ResourceSet for this SRS resource set. If more than one SRS resource set (e.g., SRS resource set ID₀ and SRS resource set ID₁) is activated, the MAC CE 500 may include multiple groups of S_{i.j} corresponding to the same DCI codepoint. For example, S_{0,7}, S_{0,6} . . . S_{0,0} at octet 3 and octet N+2 correspond to DCI codepoint 0, and S_{1,7}, S_{1,6} . . . S_{1,0} at octet 4 and octet N+3 correspond to DCI codepoint 1. For one DCI codepoint, up to 8 SRS resources (represented by S_{i,j}) across all the resource sets can be activated. For example, if X SRS resources of the SRS resource set ID₀ are activated for a certain DCI codepoint, a maximum of 8-X SRS resources can be activated for the SRS resource set ID₁ for the same codepoint. The number of DCI codepoints depends on the length of the SRS request field in the DCI.

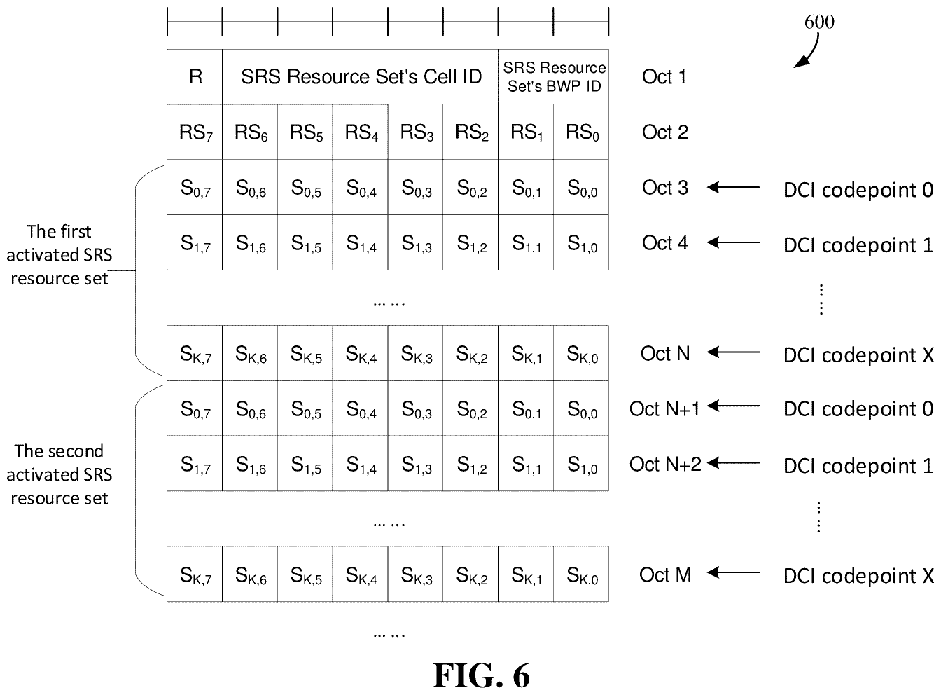

FIG. 6 is a drawing illustrating a design of a MAC CE 600 for SRS resource control according to some aspects of the disclosure. A scheduling entity 108 may transmit the MAC CE 600 to a scheduled entity 106 (e.g., UE) in an NR RAN 200 for configuring and controlling SRS communication. The MAC CE 600 has a predetermined number of bits arranged in various bit fields. Some of the bits may be reserved (denoted as R in FIG. 6). The MAC CE 600 has an SRS resource set cell ID field (shown as SRS Resource Set's Cell ID in FIG. 6) that identifies the cell that is associated with the SRS resource set(s) associated with this MAC CE. The MAC CE 600 further includes an SRS resource set BWP ID field (shown as SRS Resource Set's BWP ID in FIG. 6) that identifies the BWP that is configured with the SRS resource set(s) associated with this MAC CE.

The MAC CE 600 uses an SRS resource set bitmap to indicate whether the SRS resource sets are activated or not. An exemplary 8-bit (at octet 2) SRS resource set bitmap (R5₇, RS₆, RS₅, RS₄, RS₃, RS₂, RS₁, RS₀) is illustrated in FIG. 6. For example, if bit RS₀ is set to 1, the corresponding SRS resource set is activated; otherwise, if bit RS₀ is set to 0, the corresponding SRS resource set is deactivated. The SRS resources of the activated SRS resource set are indicated in one or more groups of S_{i,j} following the SRS resource set bitmap. Each group of S_{i,j} corresponds to an activated SRS resource set. If multiple SRS resource sets are activated, the groups of S_{i,j} are arranged in the MAC CE according to the bit order of the SRS resource set bitmap. For example, if two SRS resource sets are activated (e.g., RS₆=1 and RS₄=1), the SRS resources indicated from octet 3 to octet N correspond to the first activated SRS resource set (e.g., RS₆); and the SRS resources indicated from octet N+1 to octet M correspond to the second activated SRS resource set (e.g., RS₄). Similar to the MAC CE 500 described above in FIG. 5, a total of eight SRS sources can be activated across all activated SRS resource sets in the MAC CE 600.

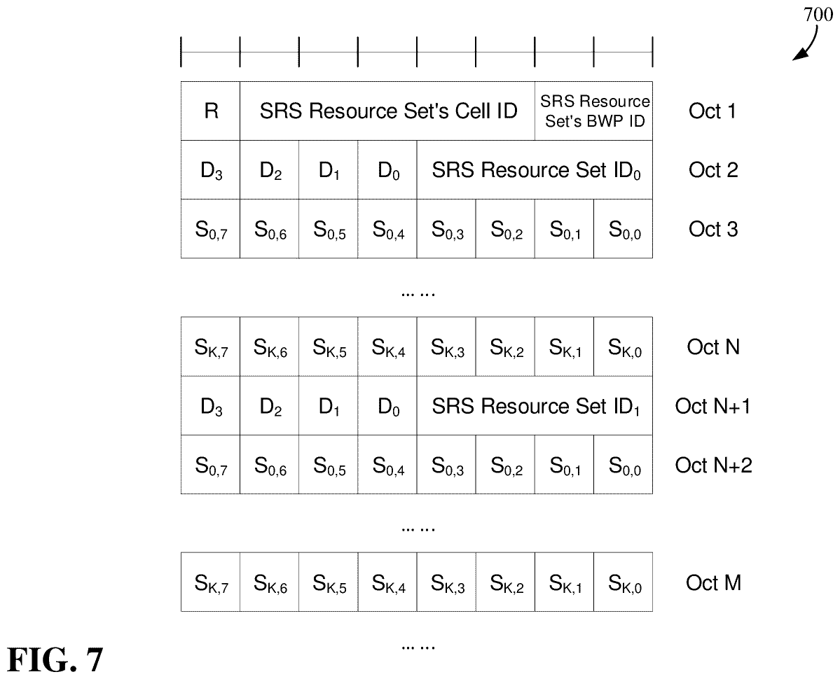

FIG. 7 is a drawing illustrating a design of a MAC CE 700 for SRS resource control according to some aspects of the disclosure. A scheduling entity 108 may transmit the MAC CE 700 to a scheduled entity 106 (e.g., UE) in an NR RAN 200 for configuring and controlling SRS communication. The MAC CE 700 has a predetermined number of bits arranged in various bit fields. Some of the bits may be reserved (denoted as R in FIG. 7). The MAC CE 700 has an SRS resource set cell ID field (shown as SRS Resource Set's Cell ID in FIG. 7) that identifies the cell that is associated with the SRS resource set(s) associated with this MAC CE. The MAC CE 700 further includes an SRS resource set BWP ID field (shown as SRS Resource Set's BWP ID in FIG. 7) that identifies the BWP that is configured with the SRS resource set(s) associated with this MAC CE.

The MAC CE 700 includes one or more SRS resource set ID fields similar to those described above in MAC CE 500. Each SRS resource set ID field indicates the SRS resource set ID to which the following SRS resources (indicated by S_{i,j}) belong to. For each SRS resource set ID, the MAC CE 700 further includes a DCI codepoint bitmap that indicates the configured DCI codepoints. For example, for a 2-bit DCI SRS request field, the DCI codepoint bitmap may include four bits (D₃, D₂, D₁, and D₀), each corresponding to a codepoint. For example, D₀ bit corresponds to codepoint 0, D₁ bit corresponds to codepoint 1, D₂ bit corresponds to codepoint 2, and D₃ bit corresponds to codepoint 3. When any of the bits (D₃, D₂, D₁, and D₀) of the DCI codepoint bitmap is activated (e.g., set to 1), the corresponding SRS resources activation and deactivation state is triggered; otherwise, if a bit of the DCI codepoint bitmap is deactivated (e.g., set to 0), the corresponding SRS resources activation and deactivation state is not triggered. The MAC CE can use the DCI codepoint bitmap to indicate a subset of DCI codepoints that are activated or configured for SRS communication. Based on the activated DCI codepoints, the activated/deactivated SRS resources associated with each activated codepoint are indicated in one or more octets (e.g., oct 3 to oct N in FIG. 7) following the associated SRS resource set ID field. For example, for SRS resource set ID₀, if the first DCI codepoint bit that is activated is D₂ (e.g., D₂=1) when counting from bit position D₃, the SRS resources S_{i,j} (e.g., S_{0,7}, S_{0,6}, S_{0,5}, S_{0,4}, S_{0,3}, S_{0,2}, S_{0,1}, S_{0,0}) in octet 3 indicate the associated SRS resources that are activated or deactivated for codepoint D₂. In this example, eight SRS resources may be controlled for a certain SRS resource set. The number of groups of SRS resource bits S_{i,j} associated with each SRS resource set depends on the number of activated codepoint bits.

Similarly, the SRS resource set IDi field has an associated DCI codepoint bitmap and one or more groups of SRS resource bits S_{i,j} according to the activated codepoints of the codepoint field (D₃, D₂, D₁, and D₀). While two SRS resource set ID fields are illustrated in FIG. 7, the MAC CE 700 may include more or fewer SRS resource set ID fields in other examples.

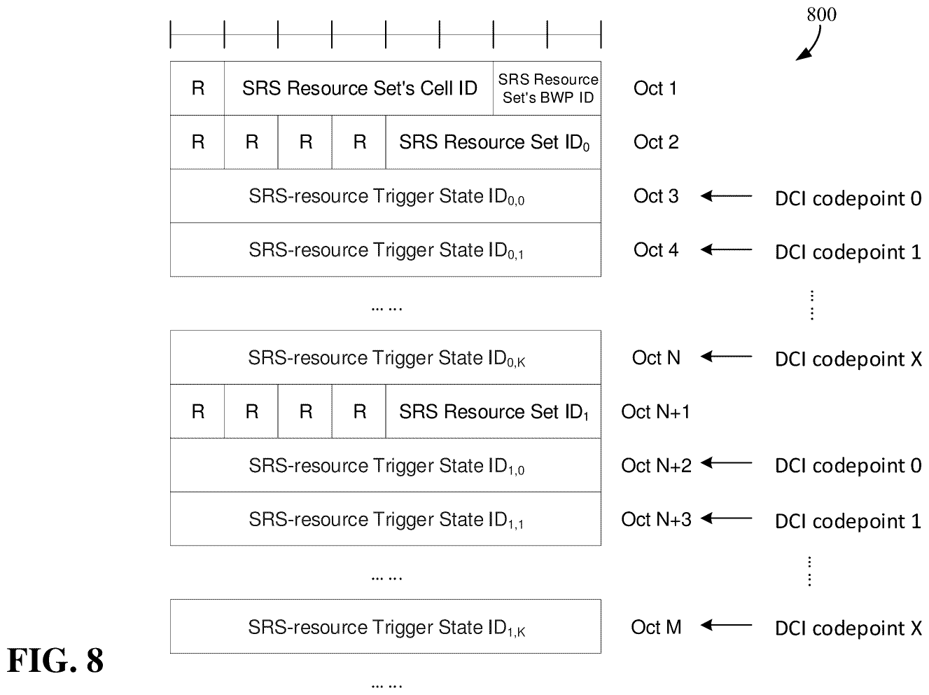

FIG. 8 is a drawing illustrating a design of a MAC CE 800 for SRS resource control according to some aspects of the disclosure. A scheduling entity 108 may transmit the MAC CE 800 to a scheduled entity 106 (e.g., UE) in an NR RAN 200 for configuring and controlling SRS communication. The MAC CE 800 has a predetermined number of bits arranged in various bit fields. Some of the bits may be reserved (denoted as R in FIG. 8). The MAC CE 800 has an SRS resource set cell ID field (shown as SRS Resource Set's Cell ID in FIG. 8) that identifies the cell that is associated with the SRS resource set(s) associated with this MAC CE. The MAC CE 800 further includes an SRS resource set BWP ID field (shown as SRS Resource Set's BWP ID in FIG. 8) that identifies the BWP that is configured with the SRS resource set(s) associated with this MAC CE.

The MAC CE 800 includes one or more SRS resource set ID fields similar to those described above in MAC CE 500. Each SRS resource set ID field indicates the SRS resource set ID to which the following SRS resource trigger states (shown as SRS-resource Trigger State ID_{i,j} in FIG. 8) belong to. In FIG. 8, SRS resource set ID₀ and SRS resource set ID₁ are illustrated as examples. The MAC CE 800 may include more or fewer SRS resource set ID fields in other examples. A scheduling entity (e.g., gNB) may use semi-persistent or semi-static scheduling (e.g., radio resource control (RRC) signaling) to pre-configure an SRS-resourceTriggerState list including a number of SRS resource trigger states for each configured SRS resource set ID. The number of SRS resource trigger states depends on the number of bits used in an SRS-resourceTriggerState ID or index that is used to indicate the desired SRS resource trigger state. For example, an 8-bit SRS-resourceTriggerState ID can indicate up to 256 SRS resource trigger states.

In some aspects of the disclosure, one SRS resource trigger state may indicate a predetermined SRS resources activation/deactivation combination preconfigured using RRC. For example, the SRS resources may be configured for SRS antenna switching, for example, with “antennaSwitching” purpose set inside the srs-ResourceldList of the RRC parameter SRS-ResourceSet for this SRS resource set. The MAC CE 800 maps an SRS-resource trigger state to a DCI codepoint for each SRS resource set. If multiple SRS resource sets are activated, the MAC CE can map multiple SRS-resource trigger states of different SRS resource sets to the same DCI codepoint.

For example, if the MAC CE 800 has two activated SRS resource sets (e.g., SRS resource set ID₀ and SRS resource set ID₁), each DCI codepoint is associated with two SRS-resource trigger states respectively corresponding to different SRS resource sets. In the example shown in FIG. 8, SRS-resource trigger state ID_{0,0} (at octet 3) and SRS-resource trigger state ID_{1,0} (at octet N+2) both are mapped to DCI codepoint 0. Therefore, the DCI codepoint 0 can trigger both states in SRS communication. In this example, for each DCI codepoint, up to 8 SRS resources cross all the resource sets can be activated.

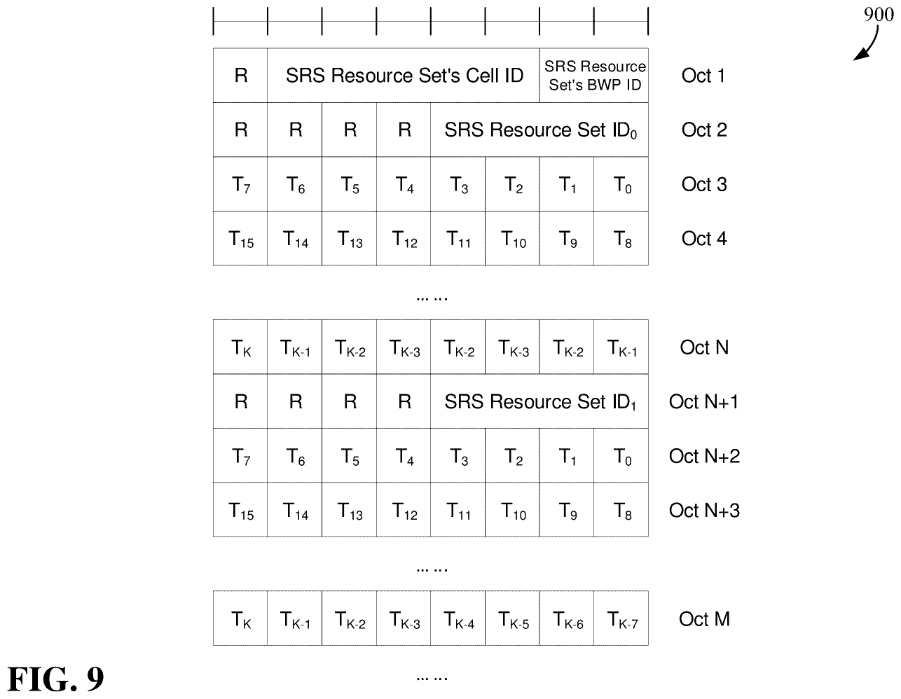

FIG. 9 is a drawing illustrating a design of a MAC CE 900 for SRS resource control according to some aspects of the disclosure. A scheduling entity 108 may transmit the MAC CE 900 to a scheduled entity 106 (e.g., UE) in an NR RAN 200 for configuring and controlling SRS communication. The MAC CE 900 has a predetermined number of bits arranged in various bit fields. Some of the bits may be reserved (denoted as R in FIG. 9). The MAC CE 900 has an SRS resource set cell ID field (shown as SRS Resource Set's Cell ID in FIG. 9) that identifies the cell that is associated with the SRS resource set(s) associated with this MAC CE. The MAC CE 900 further includes an SRS resource set BWP ID field (shown as SRS Resource Set's BWP ID in FIG. 9) that identifies the BWP that is configured with the SRS resource set(s) associated with this MAC CE.

The MAC CE 900 includes one or more SRS resource set ID fields (shown as SRS Resource Set IDᵢ in FIG. 9) similar to those described above in MAC CE 500. Each SRS resource set ID field indicates the SRS resource set that can be used for SRS communication in one or more SRS-resource trigger states. In FIG. 9, SRS Resource Set ID₀ and SRS Resource Set ID₁ are illustrated as examples. The MAC CE 900 may include more or fewer SRS resource set ID fields in other examples. A scheduling entity (e.g., gNB) may use semi-static or semi-persistent control (e.g., RRC signaling) to pre-configure an SRS-resourceTriggerState list including a number of SRS resource trigger states for SRS communication.

In this example, the maximum number of SRS resource trigger states depends on the number of bits (Tᵢ) in an SRS resource trigger bitmap included in the MAC CE. The SRS resource trigger bitmap indicates the SRS resource trigger states for the associated SRS resource set. For example, bits T₀ though T_{K} are illustrated in FIG. 9 as an example. Each bit Tᵢ represents one SRS-resourceTriggerState in the SRS-resourceTriggerState list for the associated SRS resource set. When a Tᵢ bit is activated (e.g., set to 1), the corresponding SRS-resource trigger state i is mapped to a corresponding codepoint of the DCI SRS request field. The codepoint to which the SRS-resource trigger state is mapped is determined by its ordinal position among all the SRS-resource trigger states with the Tᵢ field activated. For example, if only T₀ and T₄ are activated for a certain SRS resource set, the ordinal position of T₀ is earlier than T₄ if counting starts from T₀. In this case, the SRS-resource trigger state of T₀ may be mapped to codepoint 0, and the SRS-resource trigger state of T₄ may be mapped to the next codepoint 1. The same concept can be used to map more activated SRS-resource trigger states to the codepoints based on the ordinal positions of the Tᵢ bits. When multiple SRS resource sets (e.g., SRS Resource Set ID₀ and SRS Resource Set ID₁) are activated in the MAC CE, each activated Tᵢ indicates that the SRS-resource trigger state i for the corresponding SRS resource set is mapped to the DCI codepoint as described above based on the ordinal position of the activated Tᵢ among the SRS resource trigger bitmap.

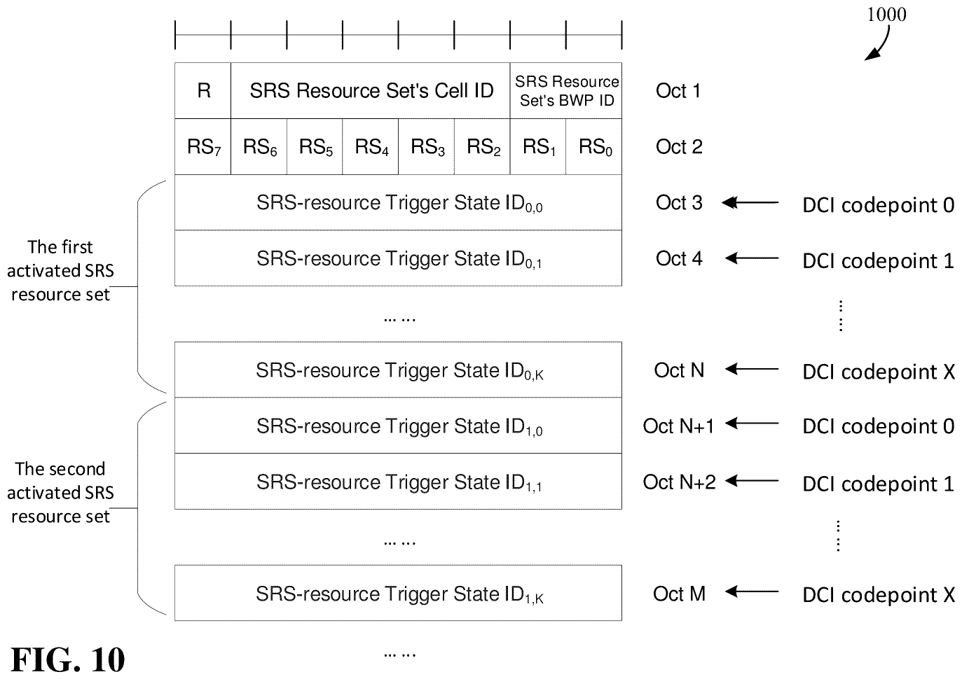

FIG. 10 is a drawing illustrating a design of a MAC CE 1000 for SRS resource control according to some aspects of the disclosure. A scheduling entity 108 may transmit the MAC CE 1000 to a scheduled entity 106 (e.g., UE) in an NR RAN 200 for configuring and controlling SRS communication. The MAC CE 1000 has a predetermined number of bits arranged in various bit fields. Some of the bits may be reserved (denoted as R in FIG. 10). The MAC CE 1000 has an SRS resource set cell ID field (shown as SRS Resource Set's Cell ID in FIG. 10) that identifies the cell that is associated with the SRS resource set(s) associated with this MAC CE. The MAC CE 1000 further includes an SRS resource set BWP ID field (shown as SRS Resource Set's BWP ID in FIG. 10) that identifies the BWP that is configured with the SRS resource set(s) associated with this MAC CE.

The MAC CE 1000 uses an SRS resource set bitmap to indicate whether the SRS resource sets are activated or not. An exemplary 8-bit (at octet 2) SRS resource set bitmap (RS₇, RS₆, RS₅, RS₄, RS₃, RS₂, RS₁, RS₀) is illustrated in FIG. 10. For example, if bit RS₀ is set to 1, the corresponding SRS resource set is activated for SRS communication; otherwise, if bit RS₀ is set to 0, the corresponding SRS resource set is deactivated for SRS communication.

A scheduling entity (e.g., gNB) may use semi-persistent or semi-static control (e.g., RRC signaling) to pre-configure an SRS-resourceTriggerState list that includes a number of SRS resource trigger states for each SRS resource set. The number of SRS resource trigger states depends on the number of bits used in an SRS-resourceTriggerState ID or index that is used to indicate the desired SRS resource trigger state. For example, an 8-bit SRS-resourceTriggerState ID can indicate up to 256 SRS resource trigger states.

In some aspects of the disclosure, an SRS resource trigger state may be associated with a predetermined SRS resources activation/deactivation combination preconfigured using RRC. For example, the available SRS resources may be configured for SRS antenna switching, for example, with “antennaSwitching” purpose set inside the srs-ResourceldList of the RRC parameter SRS-ResourceSet for this SRS resource set. The MAC CE 1000 may map one SRS-resource trigger state to each DCI codepoint for each activated SRS resource set. If multiple SRS resource sets are activated according to the SRS resource set bitmap, the MAC CE maps multiple SRS-resource trigger states of different SRS resource sets to the same DCI codepoint

In one example, if the MAC CE 1000 has two activated SRS resource sets (e.g., both RS₆ and RS₄ are set to 1), the MAC CE 1000 provides two sets of SRS-resource trigger state ID fields (shown as SRS-resource Trigger State ID_{i,j} in FIG. 10) following the SRS resource set bitmap at octet 2. Each set of SRS-resource trigger state ID fields correspond to one activated SRS resource set. Therefore, each DCI codepoint is associated with two SRS-resource trigger states. For example, SRS-resource Trigger State ID_{0,0} (at octet 3) and SRS-resource Trigger State ID_{1,0} (at octet N+1) correspond to DCI codepoint 0. For one DCI codepoint, up to 8 SRS resources across all the resource sets can be activated.

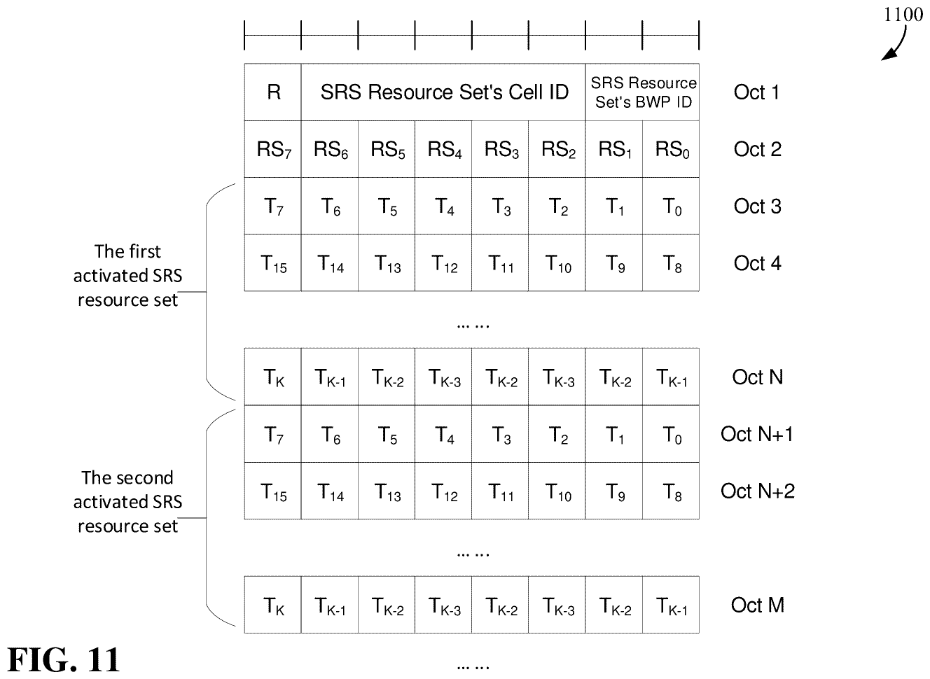

FIG. 11 is a drawing illustrating a design of a MAC CE 1100 for SRS resource control according to some aspects of the disclosure. A scheduling entity 108 may transmit the MAC CE 1100 to a scheduled entity 106 (e.g., UE) in an NR RAN 200 for configuring and controlling SRS communication. The MAC CE 1100 has a predetermined number of bits arranged in various bit fields. Some of the bits may be reserved (denoted as R in FIG. 11). The MAC CE 1100 has an SRS resource set cell ID field (shown as SRS Resource Set's Cell ID in FIG. 11) that identifies the cell that is associated with the SRS resource set(s) associated with this MAC CE. The MAC CE 1100 further includes an SRS resource set BWP ID field (shown as SRS Resource Set's BWP ID in FIG. 11) that identifies the BWP that is configured with the SRS resource set(s) described in this MAC CE.

The MAC CE 1100 uses an SRS resource set bitmap to indicate which resource sets are activated or deactivated. An exemplary 8-bit SRS resource set bitmap (RS₇, RS₆, RS₅, RS₄, RS₃, RS₂, RS₁, RS₀) is illustrated in FIG. 11. For example, if bit RSo is set to 1, the corresponding SRS resource set is activated; otherwise, if bit RS₀ is set to 0, the corresponding SRS resource set is deactivated.

A scheduling entity (e.g., gNB) may use semi-persistent or semi-static control (e.g., RRC signaling) to pre-configure an SRS-resourceTriggerState list that includes a number of SRS resource trigger states for each SRS resource set. The number of SRS resource trigger states depends on the number of bits (Tᵢ) used in the SRS resources trigger bitmap in the MAC CE 1100 to indicate the available SRS resource triggering states. For example, two groups of bits T₀ though T_{K} are illustrated in FIG. 11. Each bit Tᵢ of the SRS resources trigger bitmap represents one SRS-resourceTriggerState in the SRS-resourceTriggerState list for the associated SRS resource set. When a Tᵢ bit is activated (e.g., set to 1), the corresponding SRS-resource trigger state i is mapped to a corresponding codepoint of the DCI SRS request field. The codepoint to which the SRS-resource trigger state is mapped is determined by the bit's ordinal position among all the SRS-resource trigger states with the Tᵢ field activated. For example, if only T₀ and T₄ are activated, the ordinal position of T₀ is earlier than T₄ (if counting starts from T₀). In this case, the SRS-resource trigger state of T₀ may be mapped to codepoint 0, and the SRS-resource trigger state of T₄ may be mapped to the next codepoint 1. The same concept can be used to map more activated SRS-resource trigger states to the codepoints based on the ordinal positions of the Tᵢ bits in the bitmap.

When multiple SRS resource sets are activated in the MAC CE 1100, the MAC CE includes a separate SRS resources trigger bitmap for each activated SRS resource set. Two exemplary SRS resources trigger bitmaps are shown in FIG. 11. In each SRS resources trigger bitmap, the activated Tᵢ field indicates that the SRS-resource trigger state i for the corresponding SRS resource set is mapped to the DCI codepoint based on the ordinal position of the activated Tᵢ.

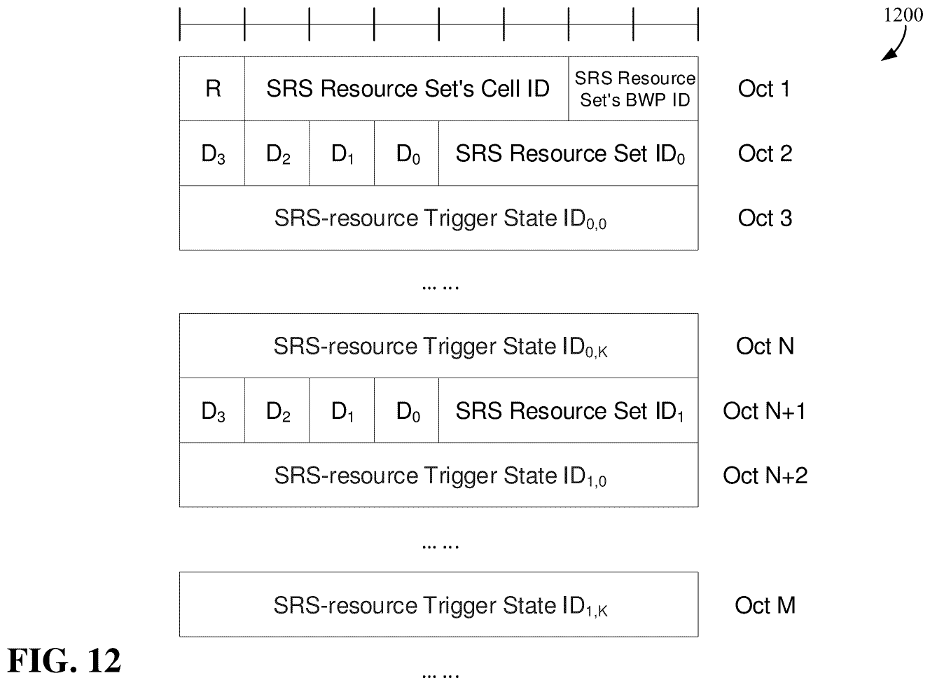

FIG. 12 is a drawing illustrating a design of a MAC CE 1200 for SRS resource control according to some aspects of the disclosure. A scheduling entity 108 may transmit the MAC CE 1200 to a scheduled entity 106 (e.g., UE) in an NR RAN 200 for configuring and controlling SRS communication. The MAC CE 1200 has a predetermined number of bits arranged in various bit fields. Some of the bits may be reserved (denoted as R in FIG. 12). The MAC CE 1200 has an SRS resource set cell ID field (shown as SRS Resource Set's Cell ID in FIG. 12) that identifies the cell that is associated with the SRS resource set(s) associated with this MAC CE. The MAC CE 1200 further includes an SRS resource set BWP ID field (shown as SRS Resource Set's BWP ID in FIG. 12) that identifies the BWP that is configured with the SRS resource set(s) associated with this MAC CE.

The MAC CE 1200 includes one or more SRS resource set ID fields similar to those described above, for example, in MAC CE 500. Each SRS resource set ID field indicates the SRS resource set to which the following SRS-resource trigger states belong to. For each SRS resource set ID, the MAC CE 1200 includes a DCI codepoint bitmap that indicates the configured DCI codepoints. For example, for a 2-bit DCI SRS request field, the DCI codepoint bitmap includes four bits (D₃, D₂, D₁, and D₀), each corresponding to a codepoint. For example, D₀ bit corresponds to codepoint 0, D₁ bit corresponds to codepoint 1, D₂ bit corresponds to codepoint 2, and D₃ bit corresponds to codepoint 3. When any of the bits of the DCI codepoint bitmap is activated (e.g., set to 1), the corresponding SRS state is triggered; otherwise, if a bit of the DCI codepoint bitmap is deactivated (e.g., set to 0), the corresponding SRS state is not triggered. The MAC CE 1200 can use the DCI codepoint bitmap to indicate a subset of DCI codepoints that are activated or configured for SRS communication. Based on the activated DCI codepoints, the activated/deactivated SRS resources associated with each activated codepoint are indicated in one or more SRS resource trigger states following the associated SRS resource set ID field.

A scheduling entity (e.g., gNB) may use semi-persistent or semi-static control (e.g., RRC signaling) to pre-configure an SRS-resourceTriggerState list including a number of SRS resources trigger states for each SRS resource set ID. For example, the MAC CE 1200 provides SRS-resource Trigger State ID_{0,0} to SRS-resource Trigger State ID_{0,K} for the SRS Resource Set ID₀. The MAC CE 1200 further provides SRS-resource Trigger State ID_{1,0} to SRS-resource Trigger State ID_{1,K} for the SRS Resource Set IDi. Each SRS resources trigger state corresponds to a predetermined SRS resources activation/deactivation combination. The MAC CE 1200 provides one SRS resources trigger state mapped to each active DCI codepoint for each SRS resource set included in the MAC CE. Therefore, if multiple SRS resource sets are activated, the MAC CE includes multiple SRS resources trigger states corresponding to the same DCI codepoint.

The codepoint to which an SRS resource trigger state is mapped is determined by the ordinal position of the codepoint in the bitmap. For example, if only D₀ and D₃ are activated for SRS Resource Set ID₀, the ordinal position of D₀ is earlier than D₃ (if counting start from D₀). In this case, SRS-resource Trigger State ID_{0,0} may be mapped to codepoint 0, and SRS-resource Trigger State ID_{0,1} may be mapped to the next codepoint 3. The same concept can be used to map more activated SRS resources trigger states to the codepoints based on the ordinal positions of the activated codepoints in the bitmap.

In some aspects of the disclosure, a scheduling entity (e.g., gNB) can transmit a MAC CE to a scheduled entity (e.g., UE) to change a slot offset associated with an SRS resource set (e.g., aperiodic SRS). An SRS slot offset is the number of slots between the triggering DCI and the actual transmission of the corresponding SRS. Using a MAC CE to change the SRS slot offset may achieve lower latency than using semi-static control (e.g., RRC signaling or the like). In some examples, the scheduling entity may use RRC to configure a default or initial SRS slot offset, and use a MAC CE to update the slot offset as needed. In some examples, a MAC CE may include a slot offset field that provides the value of the desired slot offset. In some examples, the slot offset field may have a value of 0 or any predetermined value to indicate no change to the default or current SRS slot offset. In some examples, the information for updating the SRS slot offset may be included in any of the MAC CEs described above in relation to FIGS. 5-12.

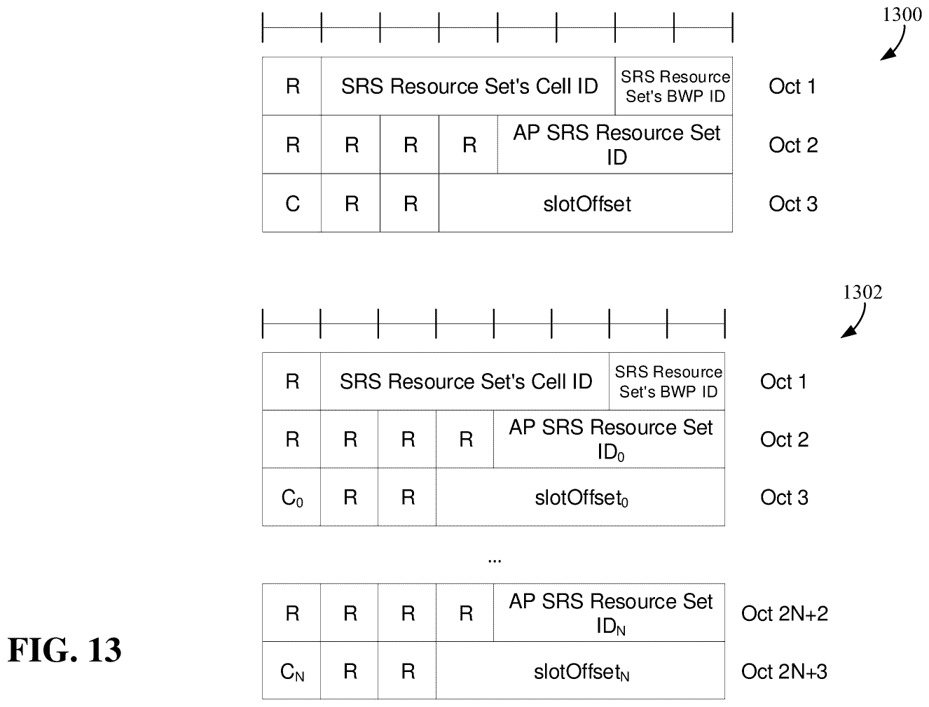

FIG. 13 is a drawing illustrating two exemplary MAC CE designs for updating an SRS resource slot offset according to some aspects of the disclosure. A scheduling entity 108 may transmit a MAC CE 1300 or MAC CE 1302 to a scheduled entity 106 (e.g., UE) in an NR RAN 200 for updating a slot offset of an aperiodic SRS resource set. The MAC CE 1300/1302 has a predetermined number of bits arranged in various bit fields. Some of the bits may be reserved (denoted as R in FIG. 13). The MAC CE 1300 may provide one slot offset for one aperiodic SRS resource set. The MAC CE 1302 may provide the multiple slot offsets for multiple aperiodic SRS resource sets. The MAC CE 1300/1302 has an SRS resource set cell ID field (shown as SRS Resource Set's Cell ID in FIG. 13) that identifies the cell that is associated with the SRS resource set(s) associated with this MAC CE. The MAC CE 1300/1302 further includes an SRS resource set BWP ID field (shown as SRS Resource Set's BWP ID in FIG. 13) that identifies the BWP that is associated with the SRS resource set(s) associated with this MAC CE.

The MAC CE 1300/1302 includes one or more SRS resource set ID fields. Two exemplary SRS resource set ID fields (e.g., AP SRS Resource Set ID₀ and AP SRS Resource Set ID_{N}) are illustrated for MAC CE 1302. In some examples, each SRS resource set ID field may correspond to an aperiodic SRS resource set. For each SRS resource set ID field, the MAC CE 1300/1302 includes a slot offset field that can indicate a slot offset of the associated SRS resource set. Two exemplary slot offset fields (e.g., slotOffset₀ and slotOffset_{N}) are illustrated in MAC CE 1302. When an SRS resource set includes a large number of SRS resources, the MAC CE 1300/1302 enables a scheduling entity to dynamically update or change the SRS slot offset, such that the scheduled entity can improve the multiplexing of the SRS resource sets with other UL channels using a variety of slot formats and dynamic slot format changes.

In one example, the slot offset field (e.g., slotOffset₀ ) may be a 5-bit field. In other examples, the slot offset field may have more or fewer bits than 5 bits. The MAC CE 1300 may have a C field (e.g., C₀ and C_{N} illustrated in FIG. 13) to modify the range or value indicated by the corresponding SRS slot offset field. The C field (may be called content field in this disclosure) allows the slot offset field to represent alternative values depending on the value of the C field. In one aspect, if C is set to a first value (e.g., 1), the 5-bit slot offset field can indicate a value from 1 to 32; and if C is set to a second value (e.g., 0,) the SRS slot offset field can indicate 0. In another aspect, if C is set to a first value (e.g., 1), the 5-bit slot offset field can indicate a value from 0 to 31; and if C is set to a second value (e.g., 0), the SRS slot offset field can indicate 32. In some examples, a scheduling entity can use the MAC CE 1300 to update the SRS slot offset of one or more aperiodic SRS resource sets. To this end, the MAC CE 1300 may include one or more pairs of C fields and SRS slot offset fields (e.g., C₀/slotOffset₀, C₁/slotOffset₁ . . . C_{N}/slotOffset_{N}) respectively corresponding to a plurality of SRS resource sets.

In some aspects of the disclosure, all or some of the above-described information of the MAC CE 1300 may be included in any of the MAC CEs described in relation to FIGS. 5-12.

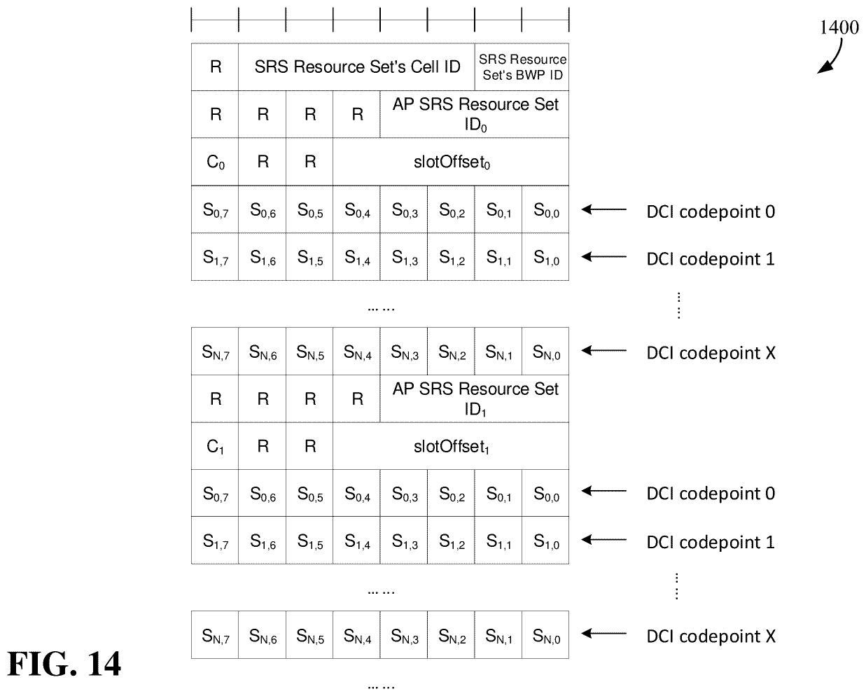

FIG. 14 is a drawing illustrating a design of a MAC CE 1400 for aperiodic SRS resource control and slot offset update according to some aspects of the disclosure. A scheduling entity 108 may transmit the MAC CE 1400 to a scheduled entity 106 (e.g., UE) in an NR RAN 200 for triggering aperiodic SRS and/or updating a slot offset of one or more aperiodic SRS resource sets. The MAC CE 1400 has a predetermined number of bits arranged in various bit fields. Some of the bits may be reserved (denoted as R in FIG. 14). The MAC CE 1400 has an SRS resource set cell ID field (shown as SRS Resource Set's Cell ID in FIG. 14) that identifies the cell that is configured with the SRS resource set(s) associated with this MAC CE. The MAC CE 1400 further includes an SRS resource set BWP ID field (shown as SRS Resource Set's BWP ID in FIG. 14) that identifies the BWP that is configured with the SRS resource set(s) associated with this MAC CE.

The MAC CE 1400 further includes one or more SRS resource set ID fields (shown as AP SRS Resource Set IDᵢ). Each SRS Resource Set ID field indicates an aperiodic SRS resource set to which the following SRS resources (S_{i,j}) belong to. Two exemplary SRS resource set ID fields (e.g., AP SRS Resource Set ID₀ and AP SRS Resource Set ID₁) are illustrated in FIG. 14. In other examples, the MAC CE 1400 may have more or fewer SRS Resource Set ID fields than shown in FIG. 14. The S_{i,j} fields represent the SRS resources within a corresponding SRS resource set (e.g., aperiodic SRS resource set) identified by the SRS resource set ID field. In one example, if S_{i,j} is set to 1, the corresponding SRS resource is activated (i.e., turned on or enabled); otherwise, the SRS resource is deactivated (i.e., turned off or disabled).

The MAC CE 1400 further includes a C field and a slot offset field as described above for each SRS resource set configured in the MAC CE. Two exemplary C fields (e.g., C₀ and C₁) and two exemplary slot offset fields (e.g., slotOffseto and slotOffseti) are illustrated in FIG. 14. Each slot offset field indicates a value of the SRS slot offset of the associated SRS resource set. Each C field indicates how to interpret the value of the SRS slot offset field. The C fields and slot offset fields are substantially the same as those described in FIG. 13, and their redundant description will not be repeated here.

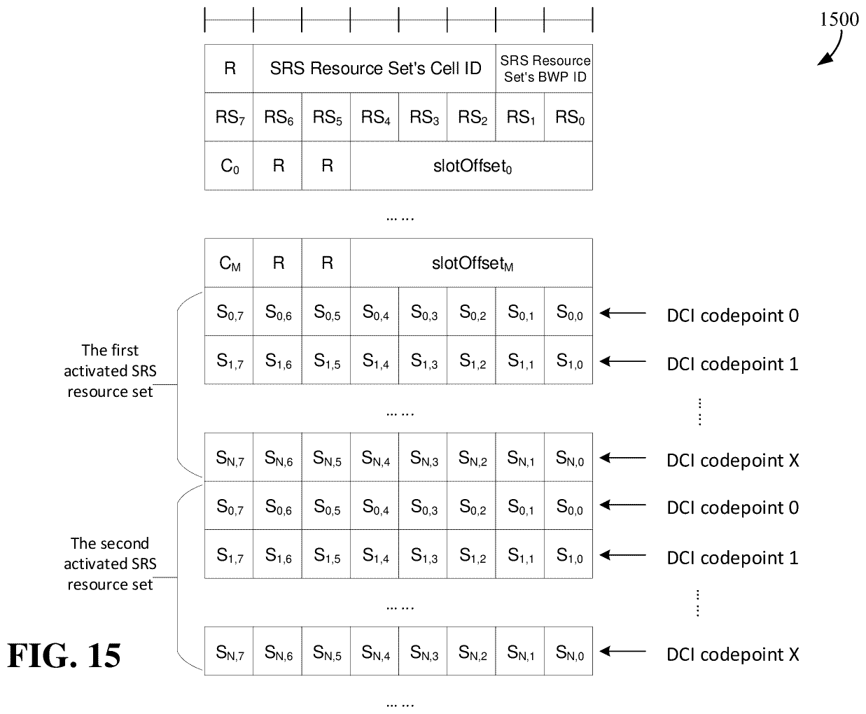

FIG. 15 is a drawing illustrating a design of a MAC CE 1500 for SRS resource control and slot offset update according to some aspects of the disclosure. A scheduling entity 108 may transmit the MAC CE 1500 to a scheduled entity 106 (e.g., UE) in an NR RAN 200 for triggering aperiodic SRS and/or updating a slot offset of one or more SRS resource sets. The MAC CE 1500 has a predetermined number of bits arranged in various bit fields. Some of the bits may be reserved (denoted as R in FIG. 15). The MAC CE 1500 has an SRS resource set cell ID field (shown as SRS Resource Set's Cell ID in FIG. 15) that identifies the cell that is configured with the SRS resource set(s) associated with this MAC CE. The MAC CE 1500 further includes an SRS resource set BWP ID field (shown as) that identifies the BWP that is configured with the SRS resource set(s) associated with this MAC CE.

The MAC CE 1500 is similar to the MAC CE 600 in terms of SRS resources control (e.g., activation/deactivation) for each configured SRS resource set. Therefore, their redundant description will not be repeated here. Different from the MAC CE 600, the MAC CE 1500 further includes a number of C fields (C₀ to C_{M}) and slot offset fields (e.g., slotOffseto to slotOffset M) corresponding to the activated aperiodic SRS resource sets based on the bitmap RS₀, RS₁, RS₂, RS₃, RS₄, RS₅, RS₆, RS₇. When any bit RSᵢ is ON (e.g., set to 1), the corresponding aperiodic SRS resource set is activated. The C fields and slot offset fields are substantially the same as those described in FIG. 13, and their redundant description will not be repeated here.

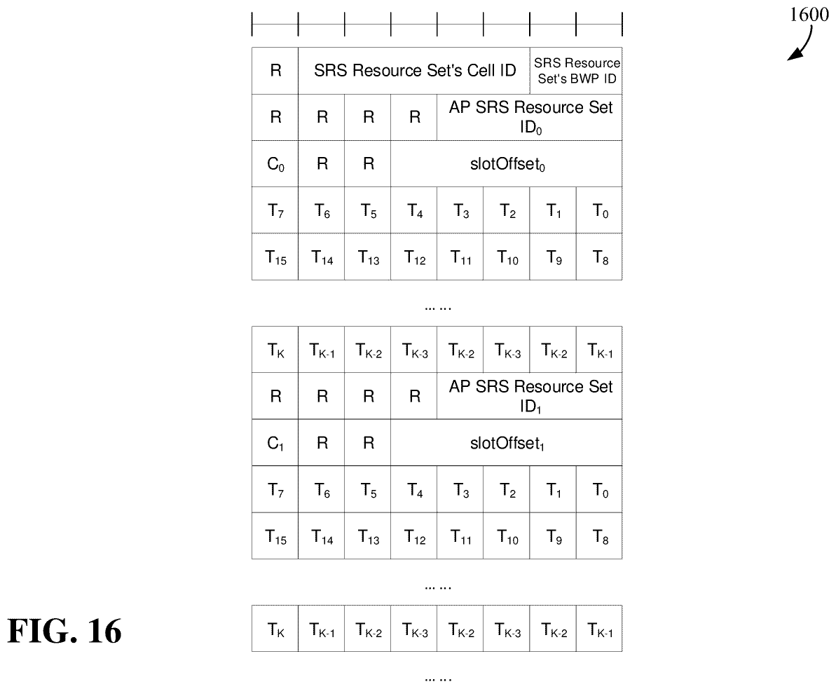

FIG. 16 is a drawing illustrating a design of a MAC CE 1600 for aperiodic SRS resource control and slot offset update according to some aspects of the disclosure. A scheduling entity 108 may transmit the MAC CE 1600 to a scheduled entity 106 (e.g., UE) in an NR RAN 200 for triggering aperiodic SRS and/or updating the slot offset of one or more SRS resource sets. The MAC CE 1600 has a predetermined number of bits arranged in various bit fields. Some of the bits may be reserved (denoted as R in FIG. 16). The MAC CE 1600 has an SRS resource set cell ID field (shown as SRS Resource Set's Cell ID in FIG. 16) that identifies the cell that is configured with the SRS resource set(s) associated with this MAC CE. The MAC CE 1600 further includes an SRS resource set BWP ID field (shown as SRS Resource Set's BWP ID in FIG. 16) that identifies the BWP that is configured with the SRS resource set(s) associated with this MAC CE.

The MAC CE 1600 is similar to the MAC CE 900 in terms of SRS resources control (e.g., activation/deactivation) for each configured SRS resource set. Therefore, their redundant description will not be repeated here. Different from the MAC CE 900, the MAC CE 1600 further includes a C field and a slot offset field corresponding to each SRS resource set (e.g., aperiodic SRS resource set) included in the MAC CE 1600. The C fields and slot offset fields are substantially the same as those described in FIG. 13, and their redundant description will not be repeated here.

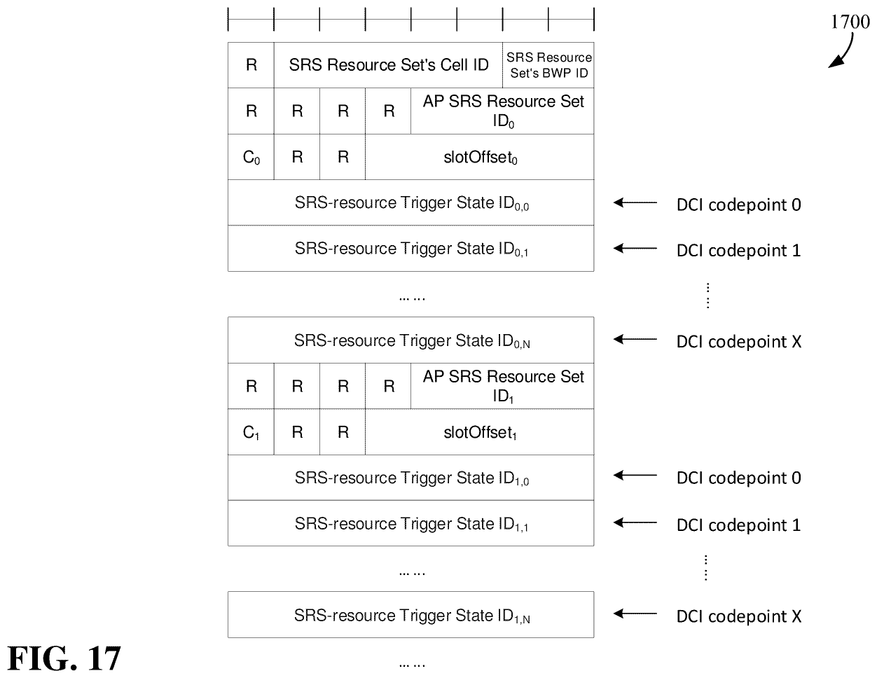

FIG. 17 is a drawing illustrating a design of a MAC CE 1700 for aperiodic SRS resource control and slot offset update according to some aspects of the disclosure. A scheduling entity 108 may transmit the MAC CE 1700 to a scheduled entity 106 (e.g., UE) in an NR RAN 200 for triggering aperiodic SRS and/or updating the slot offset of one or more SRS resource sets. The MAC CE 1700 has a predetermined number of bits arranged in various bit fields. Some of the bits may be reserved (denoted as R in FIG. 17). The MAC CE 1700 has an SRS resource set cell ID field (shown as SRS Resource Set's Cell ID in FIG. 17) that identifies the cell that is configured with the SRS resource set(s) associated with this MAC CE. The MAC CE 1700 further includes an SRS resource set BWP ID field (shown as SRS Resource Set's BWP ID in FIG. 17) that identifies the BWP that is configured with the SRS resource set(s) associated with this MAC CE.

The MAC CE 1700 is similar to the MAC CE 800 in terms of SRS resources control (e.g., activation/deactivation) for each configured SRS resource set identified by an aperiodic SRS resource set ID field (e.g., AP SRS Resource Set ID₀ and AP SRS Resource Set ID₁ illustrated in FIG. 17). Therefore, their redundant description will not be repeated here. Different from the MAC CE 800, the MAC CE 1700 further includes a C field and a slot offset field corresponding to each aperiodic SRS resource set included in the MAC CE 1700. For example, the MAC CE 1700 includes a C₀ field and a slotOffset₀ field for the AP SRS Resource Set ID₀, and a C₁ field and a slotOffset₁ field for the AP SRS Resource Set ID₁. The C fields and slot offset fields are substantially the same as those described in FIG. 13, and their redundant description will not be repeated here.

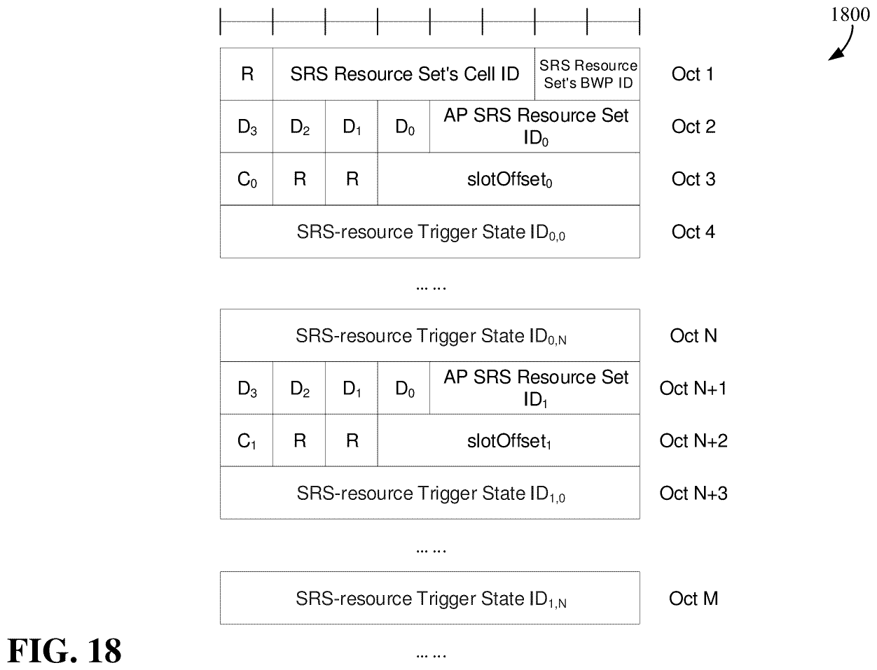

FIG. 18 is a drawing illustrating a design of a MAC CE 1800 for aperiodic SRS resource control and slot offset update according to some aspects of the disclosure. A scheduling entity 108 may transmit the MAC CE 1800 to a scheduled entity 106 (e.g., UE) in an NR RAN 200 for triggering aperiodic SRS and/or updating the slot offset of one or more aperiodic SRS resource sets. The MAC CE 1800 has a predetermined number of bits arranged in various bit fields. Some of the bits may be reserved (denoted as R in FIG. 18). The MAC CE 1800 has an SRS resource set cell ID field (shown as SRS Resource Set's Cell ID in FIG. 18) that identifies the cell that is configured with the SRS resource set(s) associated with this MAC CE. The MAC CE 1800 further includes an SRS resource set BWP ID field (shown as SRS Resource Set's BWP ID in FIG. 18) that identifies the BWP that is configured with the SRS resource set(s) associated with this MAC CE.

The MAC CE 1800 is similar to the MAC CE 1200 in terms of SRS resources control (e.g., activation/deactivation) for each configured SRS resource set identified by an aperiodic SRS resource set ID field (e.g., AP SRS Resource Set ID₀ and AP SRS Resource Set ID₁ in FIG. 18). Therefore, their redundant description will not be repeated here. Different from the MAC CE 1200, the MAC CE 1800 further includes a C field and a slot offset field corresponding to each aperiodic SRS resource set included in the MAC CE 1800. For example, the MAC CE 1800 includes a Co field and a slotOffset₀ field for the AP SRS Resource Set ID₀, and a C₁ field and a slotOffset₁ field for the AP SRS Resource Set ID₁. The C fields and slot offset fields are substantially the same as those described in FIG. 13, and their redundant description will not be repeated here.

In Release 15 of the NR specification, when a periodic or semi-persistent SRS resource set is configured, the NZP-CSI-RS-Resourceld parameter for measurement is indicated via a higher layer RRC parameter associatedCSl-RS in SRS-ResourceSet. In this case, the associatedCSl-RS parameter provides the spatial information (e.g., beam direction/information for SRS transmission) to SRS resources within the SRS-ResourceSet. The spatial relation information of an SRS resource can be based on SS block (SSB), CSI-RS, or SRS. In an NR network, a scheduling entity may use RRC to configure the associatedCSl-RS parameter associated with the SRS-ResourceSet. However, this method is not flexible and may cause undesirable latency if the network needs to reconfigure the association. In some aspects of the disclosure, a scheduling entity (e.g., gNB) can transmit a MAC CE to a scheduled entity (e.g., UE) to update the associated CSI-RS parameter with lower latency than using RRC signaling.

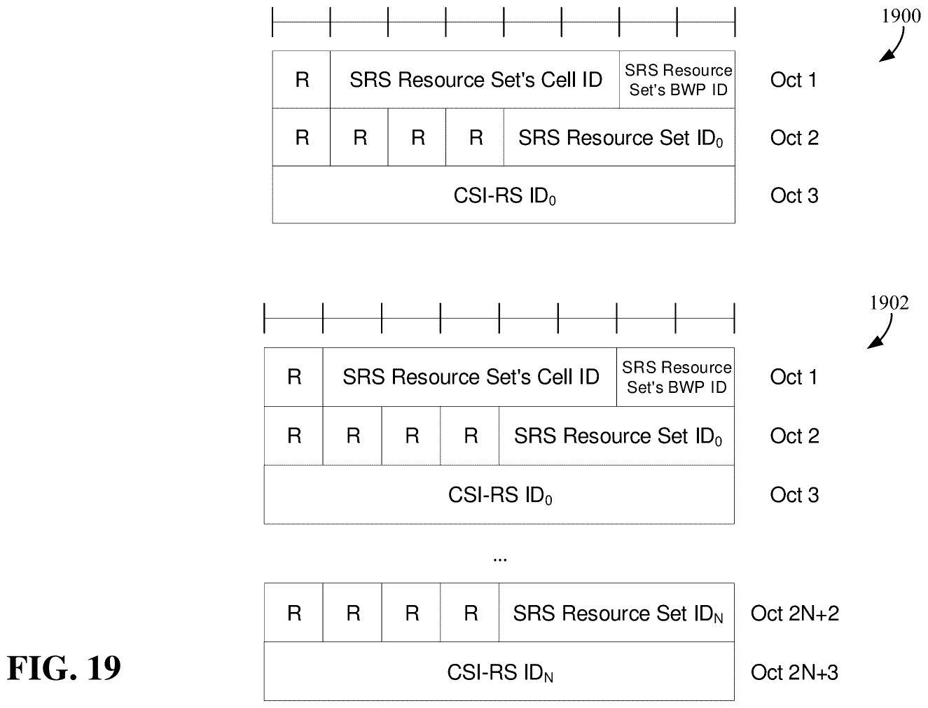

FIG. 19 is a drawing illustrating two exemplary MAC CE designs for updating the associated CSI-RS information for an SRS resource set according to some aspects of the disclosure. A scheduling entity 108 may transmit a MAC CE 1900/1902 to a scheduled entity 106 (e.g., UE) in an NR RAN 200 to update the associated CSI-RS information for one or more periodic, semi-persistent, or aperiodic SRS resource sets configured to use antenna switching. The MAC CE 1900 has a predetermined number of bits arranged in various bit fields. Some of the bits may be reserved (denoted as R in FIG. 19). The MAC CE 1900 may provide one CSI-RS information for one SRS resource set. The MAC CE 1902 may provide multiple CSI-RS information for multiple SRS resource sets. The MAC CE 1900/1902 has an SRS resource set cell ID field (shown as SRS Resource Set's Cell ID in FIG. 19) that identifies the cell that is configured with the SRS resource set(s) associated with this MAC CE. The MAC CE 1900/1902 further includes an SRS resource set BWP ID field (shown as SRS Resource Set's BWP ID in FIG. 19) that identifies the BWP that is configured with the SRS resource set(s) associated with this MAC CE.

The MAC CE 1900/1902 further includes one or more SRS resource set ID fields. Two exemplary SRS resource set ID fields (e.g., SRS Resource Set ID₀ and SRS Resource Set ID_{N}) are illustrated in MAC CE 1902. Each SRS resource set ID field indicates the SRS resource set to which the following CSI-RS ID field belongs to. In one example, the CSI-RS ID indicates the updated associatedCSl-RS from a non-zero-power (NZP) CSI-RS (NZP-CSI-RS) resource space. In MAC CE 1902, the CSI-RS ID₀ field provides the ID of the associated CSI-RS for the SRS resource set indicated by the SRS Resource Set IDo. Similarly, the CSI-RS ID_{N} field provides the ID of the associated CSI-RS for the SRS resource set indicated by the SRS Resource Set ID_{N}.

In some aspects of the disclosure, a MAC CE may include various combinations of the information of the MAC CEs described above in relation to FIGS. 5-19, such that the MAC CE can be configured to control, update, or change SRS resources activation/deactivation, aperiodic SRS slot offset, and/or associated CSI-RS information.

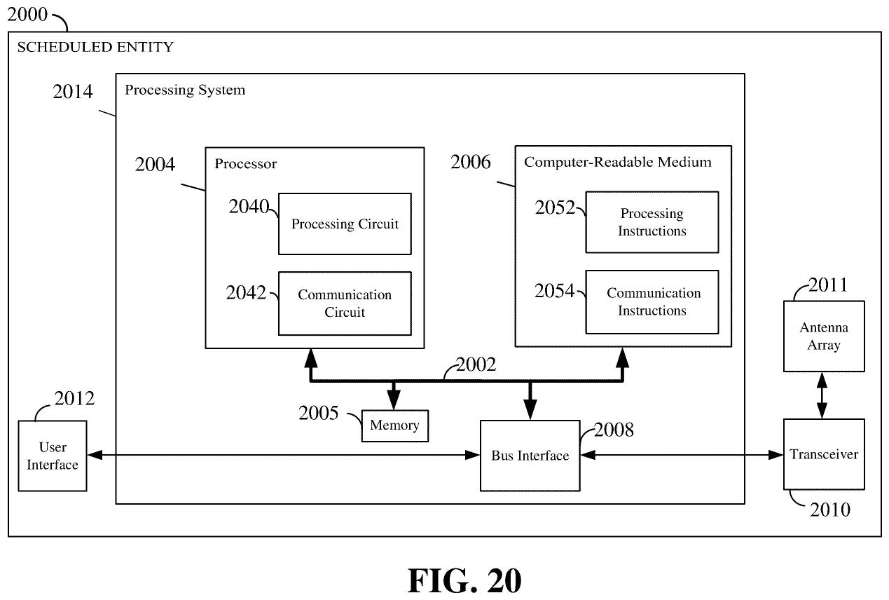

FIG. 20 is a block diagram illustrating an example of a hardware implementation for a scheduled entity 2000 employing a processing system 2014. For example, the scheduled entity 2000 may be a UE or scheduled entity as illustrated in any one or more of FIGS. 1, 2, and/or 3.

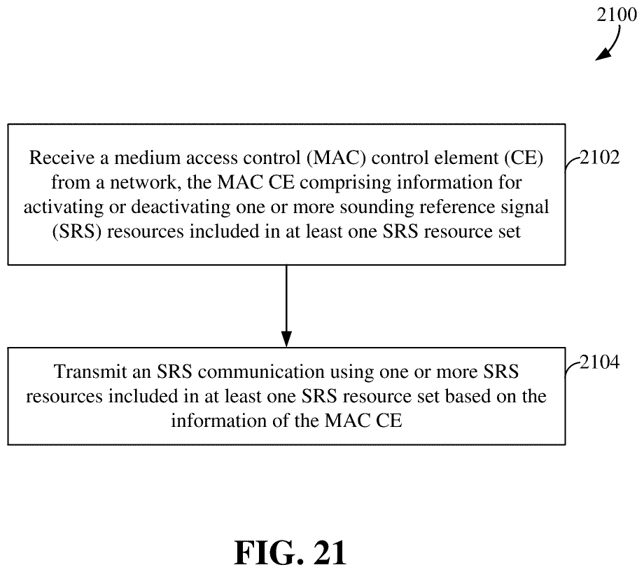

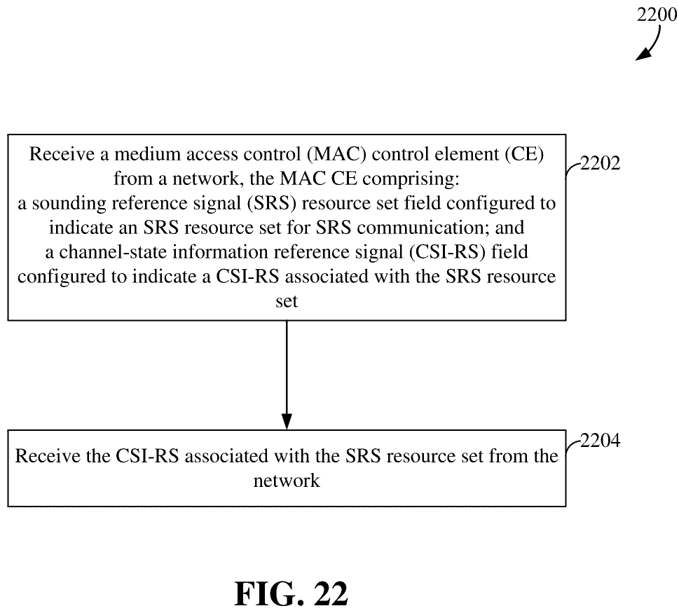

The scheduled entity 2000 may be implemented with a processing system 2014 that includes one or more processors 2004. Examples of processors 2004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduled entity 2000 may be configured to perform any one or more of the functions described herein. That is, the processor 2004, as utilized in a scheduled entity 2000, may be used to implement any one or more of the processes and procedures described and illustrated in FIGS. 21 and 22.

In this example, the processing system 2014 may be implemented with a bus architecture, represented generally by the bus 2002. The bus 2002 may include any number of interconnecting buses and bridges depending on the specific application of the processing system 2014 and the overall design constraints. The bus 2002 communicatively couples together various circuits including one or more processors (represented generally by the processor 2004), a memory 2005, and computer-readable media (represented generally by the computer-readable medium 2006). The bus 2002 may also link various other circuits such as timing sources, peripherals, voltage regulators, and power management circuits, which are well known in the art, and therefore, will not be described any further. A bus interface 2008 provides an interface between the bus 2002 and a transceiver 2010. The transceiver 2010 provides a communication interface or means for communicating with various other apparatus over a transmission medium. Depending upon the nature of the apparatus, a user interface 2012 (e.g., keypad, display, speaker, microphone, joystick) may also be provided. Of course, such a user interface 2012 is optional, and may be omitted in some examples, such as a base station.

In some aspects of the disclosure, the processor 2004 may include a processing circuit 2040 configured for various data and signal processing functions used in wireless communication, for example, including the functions and processes described in this disclosure. The processor 2004 may further include a communication circuit 2042 configured for various functions including, for example, uplink and downlink communication functions via the transceiver 2010 for enabling the functions and procedures described in this disclosure. In some examples, the transceiver 2010 may be coupled to an antenna array 2011 that includes one or more antennas that can be configured for uplink and/or downlink communication, for example, SRS communication with antenna switching.

The processor 2004 is responsible for managing the bus 2002 and general processing, including the execution of software stored on the computer-readable medium 2006. The software, when executed by the processor 2004, causes the processing system 2014 to perform the various functions described below for any particular apparatus. The computer-readable medium 2006 and the memory 2005 may also be used for storing data that is manipulated by the processor 2004 when executing software.

One or more processors 2004 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 2006. The computer-readable medium 2006 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 2006 may reside in the processing system 2014, external to the processing system 2014, or distributed across multiple entities including the processing system 2014. The computer-readable medium 2006 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 2006 may include software configured for various functions, including, wireless communication functions and procedures described in this disclosure. In some aspects of the disclosure, the computer-readable storage medium 2006 may include processing instructions 2052 configured for various data and signal processing functions used in wireless communication, for example, including the functions and processes described in this disclosure. The computer-readable storage medium 2006 may further include communication instructions 2054 configured for various functions including, for example, uplink and downlink communication functions described in this disclosure.

FIG. 21 is a flow chart illustrating an exemplary process 2100 for wireless communication between a scheduling entity and a scheduled entity using a MAC CE in accordance with some aspects of the present disclosure. As described below, some or all illustrated features may be omitted in a particular implementation within the scope of the present disclosure, and some illustrated features may not be required for implementation of all embodiments. In some examples, the process 2100 may be carried out by the scheduled entity 2000 illustrated in FIG. 20. In some examples, the process 2100 may be carried out by any suitable apparatus or means for carrying out the functions or algorithm described below.

At block 2102, a scheduled entity (e.g., a UE) receives a medium access control (MAC) control element (CE) from a network (e.g., a scheduling entity or gNB). The MAC CE includes information for activating or deactivating one or more sounding reference signal (SRS) resources included in at least one SRS resource set. In some aspects of the disclosure, the scheduled entity may use the communication circuit 2042 and the transceiver 2010 to receive the MAC CE via one or more antennas in a DL transmission from a scheduling entity (e.g., gNB or base station).

In some aspects of the disclosure, the MAC CE may be any of the MAC CEs described above in relation to FIGS. 5-19. In some examples, the MAC CE may further include an SRS slot offset field configured to indicate a slot offset of the at least one SRS resource set. In some examples, the MAC CE may further include a channel-state information reference signal (CSI-RS) field configured to indicate a CSI-RS associated with the SRS resource set.

At block 2104, the scheduled entity transmits an SRS communication using one or more SRS resources included in at least one SRS resource set based on the information of the MAC CE. In some aspects of the disclosure, the scheduled entity may use the communication circuit 2042 and the transceiver 2010 to transmit the SRS communication via one or more antennas, for example, using antenna switching for transmitting the SRS.

FIG. 22 is a flow chart illustrating an exemplary process 2200 for wireless communication between a scheduling entity and a scheduled entity using a MAC CE in accordance with some aspects of the present disclosure. As described below, some or all illustrated features may be omitted in a particular implementation within the scope of the present disclosure, and some illustrated features may not be required for the implementation of all embodiments. In some examples, the process 2200 may be carried out by the scheduled entity 2000 illustrated in FIG. 20. In some examples, the process 2200 may be carried out by any suitable apparatus or means for carrying out the functions or algorithms described below.

At block 2202, a scheduled entity (e.g., UE) receives a MAC CE from a network. In some aspects of the disclosure, the scheduled entity may use the communication circuit 2042 and the transceiver 2010 to receive the MAC CE via one or more antennas in a DL transmission from a scheduling entity (e.g., gNB or base station). In some aspects of the disclosure, the MAC CE includes an SRS resource set field configured to indicate an SRS resource set for SRS communication, and a CSI-RS field configured to indicate a CSI-RS associated with the SRS resource set.

At block 2204, the scheduled entity receives the CSI-RS associated with the SRS resource set from the network. The scheduled entity may use the communication circuit 2042 and the transceiver 2010 to receive the CSI-RS associated with the SRS resource set from the network (e.g., gNB) via one or more antennas.

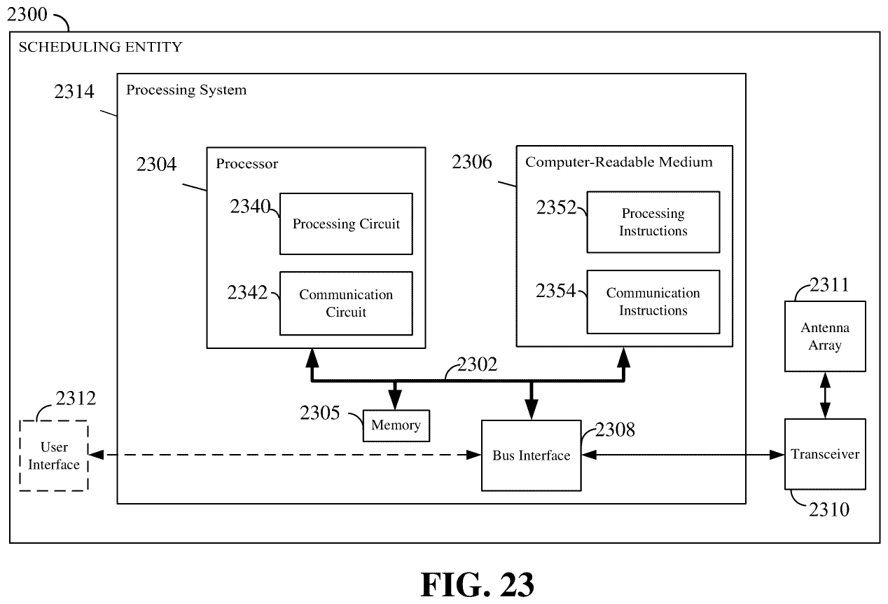

FIG. 23 is a conceptual diagram illustrating an example of a hardware implementation for an exemplary scheduling entity 2300 employing a processing system 2314. In accordance with various aspects of the disclosure, an element, or any portion of an element, or any combination of elements may be implemented with a processing system 2314 that includes one or more processors 2304. For example, the scheduling entity 2300 may be a base station or scheduling entity as illustrated in any one or more of FIGS. 1, 2, and/or 3.

The processing system 2314 may be substantially the same as the processing system 2014 illustrated in FIG. 20, including a bus interface 2308, a bus 2302, memory 2305, a processor 2304, and a computer-readable medium 2306. Furthermore, the scheduling entity 2300 may include a user interface 2312 and a transceiver 2310 substantially similar to those described above in FIG. 20. That is, the processor 2304, as utilized in a scheduling entity 2300, may be used to implement any one or more of the processes described in this disclosure.

In some aspects of the disclosure, the processor 2304 may include a processing circuit 2340 configured for various data and signal processing functions used in wireless communication, for example, including the functions and processes described in this disclosure. The processor 2304 may further include a communication circuit 2342 configured for various functions including, for example, uplink and downlink communication functions and processes via the transceiver 2310. In some examples, the transceiver 2310 may be coupled to an antenna array 2311 that includes one or more antennas that can be configured for uplink and/or downlink communication, for example, SRS communication using antenna switching.

In one or more examples, the computer-readable storage medium 2306 may include software configured for various functions, including, the functions and processes described in this disclosure. In some aspects of the disclosure, the computer-readable storage medium 2306 may include processing instructions 2352 configured for various data and signal processing functions used in wireless communication, for example, including the functions and processes described in this disclosure. The computer-readable storage medium 2306 may further include communication instructions 2354 configured for various functions including, for example, uplink and downlink communication functions, for example, SRS communication with antenna switching.

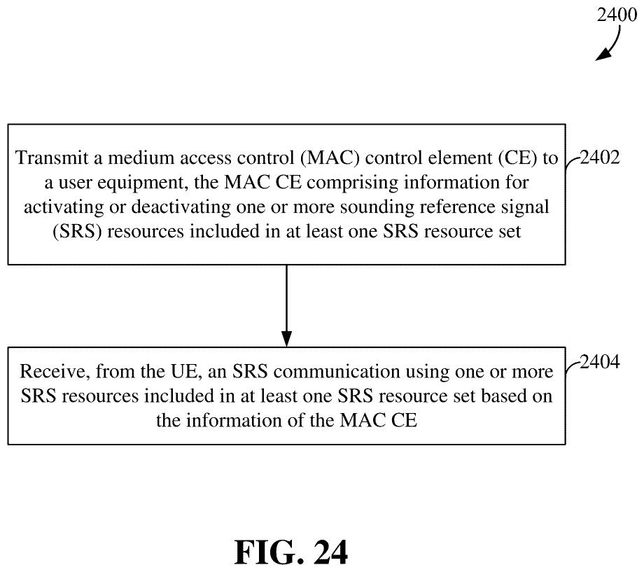

FIG. 24 is a flow chart illustrating an exemplary process 2400 for wireless communication between a scheduling entity and a scheduled entity using a MAC CE in accordance with some aspects of the present disclosure. As described below, some or all illustrated features may be omitted in a particular implementation within the scope of the present disclosure, and some illustrated features may not be required for the implementation of all embodiments. In some examples, the process 2400 may be carried out by the scheduling entity 2300 illustrated in FIG. 23. In some examples, the process 2400 may be carried out by any suitable apparatus or means for carrying out the functions or algorithms described below.

At block 2402, a scheduling entity (e.g., gNB) transmits a medium access control (MAC) control element (CE) to a scheduled entity (e.g., UE). The MAC CE includes information for controlling (e.g., activating or deactivating) one or more sounding reference signal (SRS) resources included in at least one SRS resource set. In some aspects of the disclosure, the scheduling entity may use the communication circuit 2342 and the transceiver 2310 to transmit the MAC CE via one or more antennas in a DL transmission to the scheduled entity.

In some aspects of the disclosure, the MAC CE may be any of the MAC CEs described above in relation to FIGS. 5-19. In some examples, the MAC CE may further include an SRS slot offset field configured to indicate a slot offset of the at least one SRS resource set. In some examples, the MAC CE may further include a CSI-RS field configured to indicate a CSI-RS associated with the SRS resource set.

At block 2404, the scheduling entity receives an SRS communication from the scheduled entity using one or more SRS resources included in at least one SRS resource set based on the information of the MAC CE. In some aspects of the disclosure, the scheduling entity may use the communication circuit 2342 and the transceiver 2310 to receive the SRS communication via one or more antennas, for example, UL SRS with antenna switching.

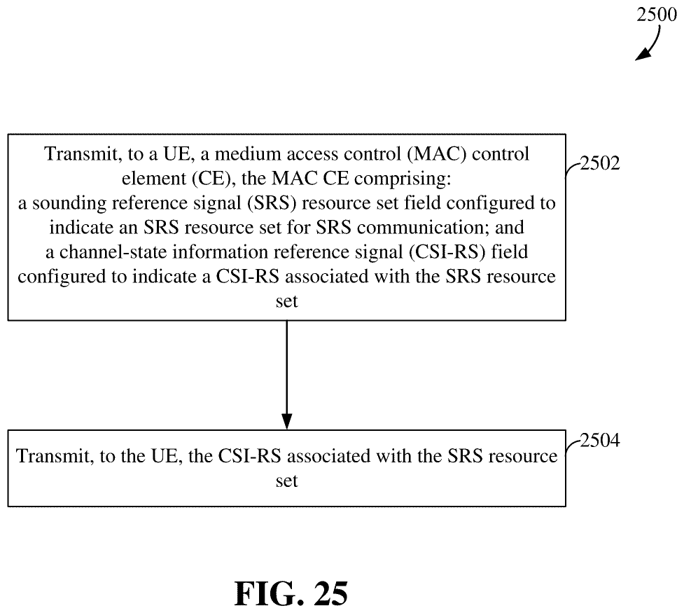

FIG. 25 is a flow chart illustrating an exemplary process 2500 for wireless communication between a scheduling entity and a scheduled entity using a MAC CE in accordance with some aspects of the present disclosure. As described below, some or all illustrated features may be omitted in a particular implementation within the scope of the present disclosure, and some illustrated features may not be required for the implementation of all embodiments. In some examples, the process 2500 may be carried out by the scheduling entity 2300 illustrated in FIG. 23. In some examples, the process 2500 may be carried out by any suitable apparatus or means for carrying out the functions or algorithms described below.

At block 2502, a scheduling entity (e.g., gNB) transmits a MAC CE to a scheduled entity (UE). In some aspects of the disclosure, the scheduling entity may use the communication circuit 2342 and the transceiver 2310 to transmit the MAC CE via one or more antennas in a DL transmission to the scheduled entity. In some aspects of the disclosure, the MAC CE includes an SRS resource set field configured to indicate an SRS resource set for SRS communication, and a CSI-RS field configured to indicate a CSI-RS associated with the SRS resource set.

At block 2504, the scheduling entity transmits the CSI-RS associated with the SRS resource set to the scheduled entity. The scheduling entity may use the communication circuit 2342 and the transceiver 2310 to transmit the CSI-RS associated with the SRS resource set to the scheduled entity (e.g., UE) via one or more antennas.

In one configuration, the apparatus 2000 and/or 2300 for wireless communication includes various means for performing the functions and processes described in this disclosure. In one aspect, the aforementioned means may be the processors 2004/2304 shown in FIG. 20/23 configured to perform the functions recited by the aforementioned means. In another aspect, the aforementioned means may be a circuit or any apparatus configured to perform the functions recited by the aforementioned means.

Of course, in the above examples, the circuitry included in the processor 2004/2304 is merely provided as an example, and other means for carrying out the described functions may be included within various aspects of the present disclosure, including but not limited to the instructions stored in the computer-readable storage medium 2006/2306, or any other suitable apparatus or means described in any one of the FIGS. 1, 2, and/or 3, and utilizing, for example, the processes and/or algorithms described herein in relation to FIGS. 20, 21, 24, and/or 25.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-25 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-25 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication at a scheduled entity, comprising:
receiving a medium access control (MAC) control element (CE) from a network, the MAC CE comprising information for activating or deactivating one or more sounding reference signal (SRS) resources included in at least one SRS resource set; and
transmitting an SRS communication using the one or more SRS resources included in the at least one SRS resource set based on the information of the MAC CE.

2. The method of claim 1, wherein the MAC CE further comprises:
an SRS slot offset field configured to indicate a slot offset between a triggering downlink control information (DCI) and the at least one SRS resource set this is activated.

3. The method of claim 2, wherein the MAC CE further comprises:
a content field configured to indicate alternative values represented by the SRS slot offset field according to a value of the content field.

4. The method of claim 1, wherein the MAC CE further comprises:
a channel-state information reference signal (CSI-RS) field configured to indicate a CSI-RS associated with the at least one SRS resource set.

5. The method of claim 1, wherein the MAC CE comprises:
an SRS resource set field configured to indicate an SRS resource set; and
an SRS resource field configured to indicate the one or more SRS resources included in the at least one SRS resource set.

6. The method of claim 5, wherein the SRS resource field is configured to activate or deactivate the one or more SRS resources according to a plurality of downlink control information (DCI) codepoints for triggering aperiodic, semi-persistent, or periodic SRS resources included in the at least one SRS resource set.

7. The method of cclaim 1, wherein the MAC CE comprises:
an SRS resource set bitmap comprising a plurality of bits, each bit configured to indicate activation or deactivation of a corresponding SRS resource set of the at least one SRS resource set; and
an SRS resource field configured to indicate the one or more SRS resources included in an activated SRS resource set of the at least one SRS resource set based on the SRS resource set bitmap.

8. The method of claim 7, wherein the SRS resource field is configured to activate or deactivate the one or more SRS resources according to a plurality of downlink control information (DCI) codepoints for triggering aperiodic, semi-persistent, or periodic SRS resources included in the activated SRS resource set.

9. The method of claim 1, wherein the MAC CE comprises:
a download control information (DCI) codepoint bitmap configured to indicate one or more activated DCI codepoints for triggering aperiodic, semi-persistent, or periodic SRS;
an SRS resource set field, associated with the DCI codepoint bitmap, configured to indicate an SRS resource set of the at least one SRS resource set; and
an SRS resource field configured to indicate the one or more SRS resources included in the SRS resource set,
wherein the SRS resource field is configured to activate or deactivate the one or more SRS resources according to the one or more activated DCI codepoints.

10. (canceled)

11. The method of claim 1, wherein the MAC CE comprises:
an SRS resource set field configured to indicate an SRS resource set of the at least one SRS resource set; and
a plurality of SRS resource trigger state fields, associated with the SRS resource set, the plurality of SRS resource trigger state fields configured to indicate a plurality of SRS resource trigger states that are preconfigured by radio resource control signaling.

12. The method of claim 11, wherein the plurality of SRS resource trigger state fields respectively correspond to a plurality of downlink control information (DCI) codepoints for triggering aperiodic, semi-persistent, or periodic SRS resources included in the SRS resource set.

13. The method of claim 11, wherein each of the plurality of SRS resource trigger states indicates activation or deactivation of each of the one or more SRS resources for the SRS resource set.

14. The method of claim 1, wherein the MAC CE comprises:
an SRS resource set field configured to indicate an SRS resource set of the at least one SRS resource set; and
an SRS trigger state bitmap with each bit indicating activation or deactivation of a corresponding SRS trigger state of the SRS resource set among a plurality of SRS trigger states that are preconfigured by radio resource control signaling,
wherein the activated SRS trigger states correspond to a plurality of downlink control information (DCI) codepoints for triggering aperiodic, semi-persistent, or periodic SRS resources included in the SRS resource set.

15. (canceled)

16. The method of claim 1, wherein the MAC CE comprises:
an SRS resource set bitmap comprising a plurality of bits, each bit configured to indicate activation or deactivation of a corresponding SRS resource set of the at least one SRS resource set; and
a plurality of SRS resource trigger state fields, associated with the corresponding SRS resource set, the plurality of SRS resource trigger state fields configured to indicate a plurality of SRS resource trigger states that are preconfigured by radio resource control signaling.

17. The method of claim 16, wherein the plurality of SRS resource trigger state fields respectively correspond to a plurality of downlink control information (DCI) codepoints for triggering aperiodic, semi-persistent, or periodic SRS sources included in the corresponding activated SRS resource set.

18. The method of claim 1, wherein the MAC CE comprises:
an SRS resource set bitmap comprising a plurality of bits, each bit configured to indicate activation or deactivation of a corresponding SRS resource set of the at least one SRS resource set; and
an SRS trigger state bitmap with each bit indicating activation or deactivation of a corresponding SRS trigger state of the corresponding SRS resource set among a plurality of SRS trigger states that are preconfigured by radio resource control signaling.

19. The method of claim 18, wherein the activated SRS trigger states correspond to a plurality of downlink control information (DCI) codepoints for triggering aperiodic, semi-persistent, or periodic SRS resources included in the corresponding activated SRS resource set.

20. The method of claim 1, wherein the MAC CE comprises:
a download control information (DCI) codepoint bitmap configured to indicate one or more activated DCI codepoints for triggering aperiodic, semi-persistent, or periodic SRS;
an SRS resource set field, associated with the DCI codepoint bitmap, configured to indicate an SRS resource set of the at least one SRS resource set; and
one or more SRS resource trigger state fields, associated with the SRS resource set, each SRS resource trigger state field configured to indicate a resource trigger state that is preconfigured by radio resource control signaling,
wherein each of the one or more SRS resource trigger state fields corresponds to one of the activated DCI codepoints.

21. (canceled)

22. A method of wireless communication at a scheduled entity, comprising:
receiving a medium access control (MAC) control element (CE) from a network, the MAC CE comprising:
a sounding reference signal (SRS) resource set field configured to indicate an SRS resource set for SRS communication; and
a channel-state information reference signal (CSI-RS) field configured to indicate a CSI-RS resource for receiving a CSI-RS signal from network.

23. The method of claim 22, wherein the CSI-RS resource is associated with the SRS resource set.

24. The method of claim 22, wherein the SRS resource set field is configured to indicate a periodic SRS resource set, a semi-persistent SRS resource set, or aperiodic SRS resource set.

25. The method of claim 22, wherein the CSI-RS field is configured to indicate the CSI-RS from a non-zero-power CSI-RS resource space.

26. A method of wireless communication at a scheduling entity, comprising:
transmitting a medium access control (MAC) control element (CE) to a user equipment (UE), the MAC CE comprising information for activating or deactivating one or more sounding reference signal (SRS) resources included in at least one SRS resource set; and
receiving, from the UE, an SRS communication using the one or more SRS resources included in the at least one SRS resource set based on the information of the MAC CE.

27. The method of claim 26, wherein the MAC CE further comprises:
an SRS slot offset field configured to indicate a slot offset between a triggering downlink control information (DCI) and the at least one SRS resource set that is activated.

28. The method of claim 27, wherein the MAC CE further comprises:
a content field configured to indicate alternative values represented by the SRS slot offset field according to a value of the content field.

29. The method of claim 26, wherein the MAC CE further comprises:
a channel-state information reference signal (CSI-RS) field configured to indicate a CSI-RS associated with the at least one SRS resource set.

30. A method of wireless communication at a scheduling entity, comprising:
transmitting a medium access control (MAC) control element (CE) to a user equipment (UE), the MAC CE comprising:
a sounding reference signal (SRS) resource set field configured to indicate an SRS resource set for SRS communication, and
a channel-state information reference signal (CSI-RS) field configured to indicate a CSI-RS resource for transmitting a CSI-RS; and
transmitting, to the UE, the CSI-RS using the CSI-RS resource.

31. The method of claim 30, wherein the CSI-RS resource is associated with the SRS resource set.

32. The method of claim 30, wherein the SRS resource set field is configured to indicate a periodic SRS resource set, a semi-persistent SRS resource set, or aperiodic SRS resource set.

33. The method of claim 30, wherein the CSI-RS field is configured to indicate the CSI-RS from a non-zero-power CSI-RS resource space.
